(19) United States
(12) Patent Application Publication
(10) Pub. No.: US 2015/0296532 A1
(43) Pub. Date: Oct. 15, 2015

(54) Access Points, Radio Communication Devices, Methods for Controlling an Access Point, and Methods for Controlling a Radio Communication Device

(71) Applicant: AGENCY FOR SCIENCE, TECHNOLOGY AND RESEARCH, Singapore (SG)

(72) Inventors: Yuan Zhou, Singapore (SG); Shoukang Zheng, Singapore (SG); Haiguang Wang, Singapore (SG); Zhongding Lei, Singapore (SG)

(73) Assignee: AGENCY FOR SCIENCE, TECHNOLOGY AND RESEARCH, Singapore (SG)

(21) Appl. No.: 14/441,415

(22) PCT Filed: Nov. 11, 2013
(86) PCT No.: PCT/SG2013/000480

§ 371 Date: May 7, 2015

(30) Foreign Application Priority Data
Nov. 9, 2012 (SG) 201208311-9
Mar. 13, 2013 (SG) 201301863-5
May 10, 2013 (SG) 201303655-3
Sep. 9, 2013 (SG) 201306776-4

(51) Int. Cl. H04W 72/12; H04W 68/02

(52) U.S. Cl. CPC H04W 72/1263; H04W 68/02; H04W 88/08

(57) ABSTRACT

According to various embodiments, an access point may be provided. The access point may include: a transmitter configured to transmit scheduling information for a page. The page may include one or more segments of a Traffic Indication Map (TIM). The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a predetermined number of bits of the TIM.

### CROSS-REFERENCE TO RELATED APPLICATIONS

The present application claims the benefit of the Singapore patent application No. 201208311-9 filed on 9 Nov. 2012, the Singapore patent application No. 201301863-5 filed on 13 Mar. 2013, the Singapore patent application No. 201303655-3 filed on 10 May 2013, and the Singapore patent application No. 201306776-4 filed on 9 Sep. 2013, the entire contents of which are incorporated herein by reference for all purposes.

### TECHNICAL FIELD

Embodiments relate generally to access points, radio communication devices, methods for controlling an access point, and methods for controlling a radio communication device.

### BACKGROUND

An access point may communicate with a mobile station. The access point may indicate to the mobile station whether it has data for the mobile station. A problem may arise if an access point communicates with a large number of mobile stations.

### SUMMARY

According to various embodiments, an access point may be provided. The access point may include: a transmitter configured to transmit scheduling information for a page. The page may include one or more segments of a Traffic Indication Map (TIM). Each of the TIM segments may include one or more bits, each bit indicating whether there is buffered data at the access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, a radio communication device may be provided. The radio communication device may include: a receiver configured to receive scheduling information for a page. The page may include one or more segments of a Traffic Indication Map (TIM). Each of the TIM segments may include one or more bits. Each bit may indicate whether there is buffered data at an access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, a method for controlling an access point may be provided. The method may include: transmitting scheduling information for a page. The page may include one or more segments of a Traffic Indication Map (TIM). Each of the TIM segments may include one or more bits, each bit indicating whether there is buffered data at the access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, a method for controlling a radio communication device may be provided. The method may include: receiving scheduling information for a page. The page may include one or more segments of a Traffic Indication Map (TIM). Each of the TIM segments may include one or more bits. Each bit may indicate whether there is buffered data at an access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a mobile radio communication system according to various embodiments;

FIG. 1B shows an access point according to various embodiments;

FIG. 1C shows a radio communication device according to various embodiments;

FIG. 1D shows a flow diagram illustrating a method for controlling an access point according to various embodiments;

FIG. 1E shows a flow diagram illustrating a method for controlling a radio communication device according to various embodiments;

FIG. 2 shows an illustration of an example for scheduling and synchronization with anchor Beacons according to various embodiments;

FIG. 3 shows an illustration of fast synchronization to an anchor Beacon according to various embodiments;

FIG. 4 shows an illustration of an access point informing a station about the Page Scheduling information duration association according to various embodiments;

FIG. 5 shows an illustration in which a station requests updated Page Scheduling information upon detection of page scheduling change according to various embodiments;

FIG. 6 shows an illustration in which all stations wish to receive DTIM (delivery traffic indication message) wake up and check AP buffer status regardless of their page number according to various embodiments;

FIG. 7 shows an illustration of a DTIM Beacon carrying the Page Scheduling information according to various embodiments;

FIG. 8 shows an illustration of a format of the Page Scheduling core information using page index and offset format according to various embodiments;

FIG. 9 shows an illustration of a Page Scheduling information format according to various embodiments;

FIG. 10 shows an illustration of a page scheduling information format according to various embodiments;

FIG. 11 shows an illustration of a page scheduling information format according to various embodiments;

FIG. 12 shows an illustration of the format of a PSC-IE (segment count information element) according to various embodiments;

FIG. 13 shows an illustration of a TIM (traffic indication map) segmentation scheme according to various embodiments;

FIG. 14 shows an illustration of a PSC-IE format according to various, embodiments;

FIG. 15 shows an illustration of a TIM segmentation with page period indication according to various embodiments;

FIG. 16 and FIG. 17 show illustrations of operating examples of periodic pages according to various embodiments;

FIG. 18 shows an illustration of a TIM segmentation scheme according to various embodiments;

FIG. 19 shows an illustration of a PSC-IE format according to various embodiments;

FIG. 20 shows an illustration of an example of start of segment and total segment indication according to various embodiments;

FIG. 21 shows an illustration of combining multiple PSC-IEs into a single one according to various embodiments;

FIG. 22 shows an illustration of a Segment Count IE with Page Period indication;

FIG. 23 shows an illustration of an operating example of TIM segmentation with Page Period indication according to various embodiments;

FIG. 24 shows an illustration of an operating example of TIM segmentation with Page Period indication for two pages according to various embodiments;

FIG. 25 shows an illustration of Page Segment Period in Segment Count IE (information element) according to various embodiments;

FIG. 26 shows an illustration of an example of mapping between page segment and TIM segment for P_{offset}=3 according to various embodiments;

FIG. 27 shows an illustration 2700 of segment scheduling according to various embodiments;

FIG. 28 shows an illustration of a calculation of a number of time units;

FIG. 29 shows an illustration of a calculation of a number of time units;

FIG. 30 shows an illustration of an example of extending the lifetime of buffered frame beyond listen interval; and

FIG. 31 shows an illustration of an example of a lifetime of a buffered frame equal to a listen interval.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the access point as described in this description may include a memory which is for example used in the processing carried out in the access point. In this context, the radio communication device as described in this description may include a memory which is for example used in the processing carried out in the radio communication device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or, a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

An access point may communicate with a mobile station. The access point may indicate to the mobile station whether it has data for the mobile station. A problem may arise if an access point communicates with a large number of mobile stations.

According to various embodiments, support for TIM (Traffic Indication Map) segmentation may be provided.

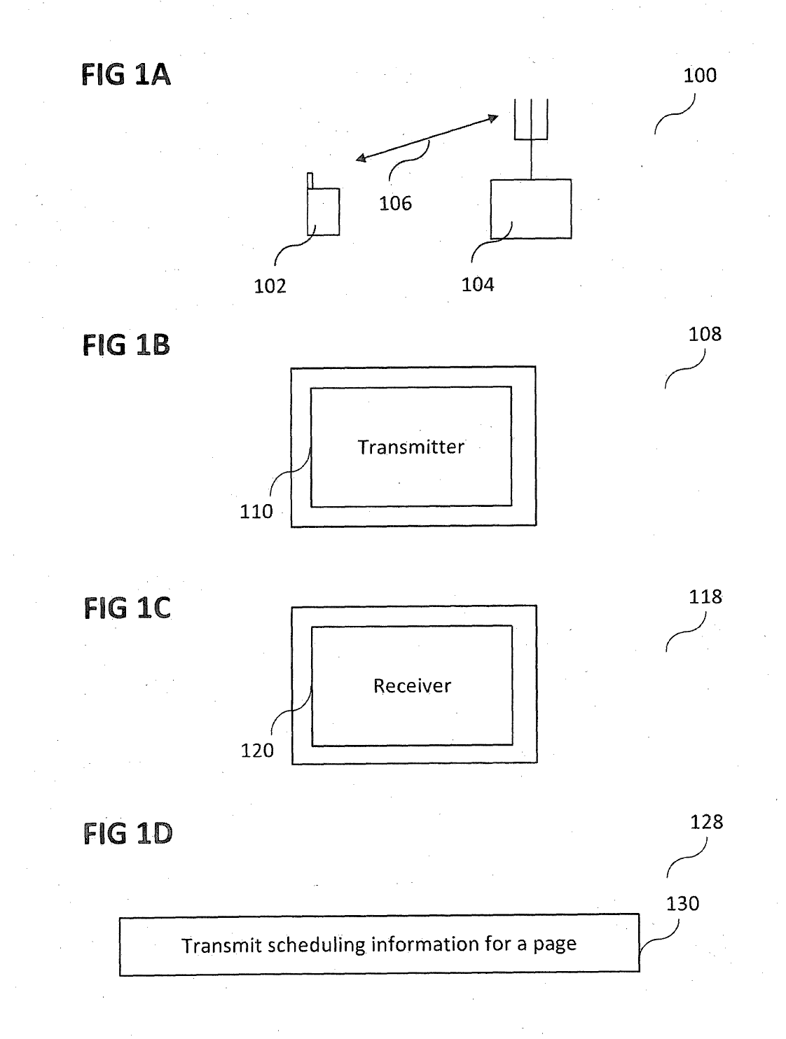

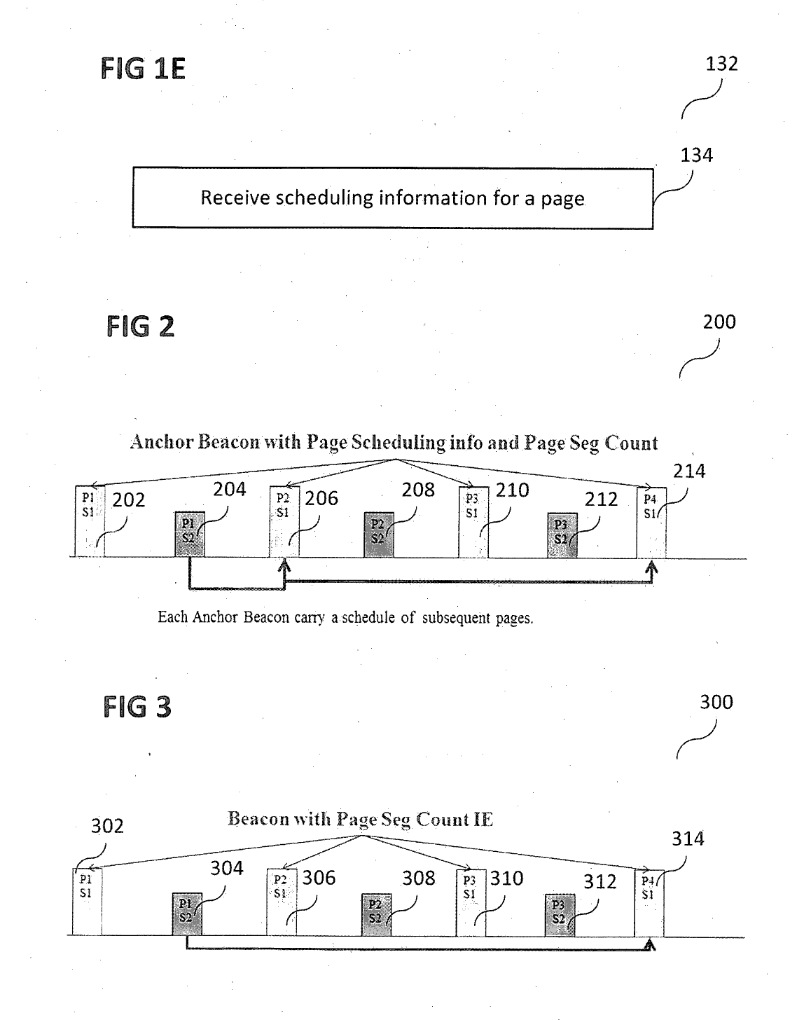

FIG. 1A shows a mobile radio communication system 100. A radio communication terminal 102 (for example a mobile station, for example referred to by STA) may communicate with an access point 104, like indicated by arrow 106. The access point 104 may indicate to the station 102 when it has data for the station 102.

FIG. 1B shows an access point 108 according to various embodiments. The access point 108 may include a transmitter 110 configured to transmit (for example to a radio communication device or to a plurality of radio communication devices) scheduling information for a page (in other words: page scheduling information). The page may include one or more segments of a Traffic Indication Map (TIM). Each of the TIM segments may include one or more bits, each bit indicating whether there is buffered data at the access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

In other words, the AP may signal explicitly the following information:
scheduling information that indicates the subsequent occurrences of the page; and/or
scheduling information that indicates the transmission schedule of one of more segments of the page. The transmission schedule information may include an indication of the offset between the transmission of the first segment included in the page scheduling and the transmission of the (page) scheduling information, and the number of blocks in each segment of the page.

It will be understood that the term “Traffic Indication Map (TIM)” is well-known in the field, but not “page” or “TIM/page segment”, which may only be defined in 802.11ah standard. In 802.11ah, a “segment” may be a subset of “page”, which may be a subset of TIM. TIM (or page) may include one or more pages (or segments). A segment may include one or more blocks, and each block may include a pre-determined number of TIM bits.

According to various embodiments, the transmitter 110 may be configured to transmit the page scheduling information in every beacon which includes a segment count information element.

According to various embodiments, the page scheduling information may include or may be an indication of the next target transmission time of the beacon that carries a segment count information element for the current page (in other words: for the associated page).

According to various embodiments, the page scheduling information may include or may be an indication of an offset between the beacon that carries the first segment of the page and the current beacon that carries the page scheduling information for the associated page.

According to various embodiments, the page scheduling information is used to determine the lifetime of buffered frames for a station.

According to various embodiments, the page scheduling information may include or may be an indication of a number of traffic indication map blocks being scheduled for the page.

According to various embodiments, the page scheduling information may include or may be an indication of number of beacon intervals between successive beacons that carry a segment count information element for the associated page.

According to various embodiments, the page scheduling information may include or may be an indication of a number of beacon intervals between successive beacons that carry a segment count information element for the page segment.

According to various embodiments, the page scheduling information may include or may be an indication of a number of beacons before the next beacon that carries a segment count information element for the associated page.

According to various embodiments, the page scheduling information may include or may be an indication of a scheduling of segments within each segmentation interval.

According to various embodiments, the page scheduling information may include or may be an indication of a page segment length in number of blocks used for the traffic indication map segmentation.

According to various embodiments, the page scheduling information may include or may be an indication of a page segment length.

According to various embodiments, the access point may be configured according to IEEE 802.11ah.

FIG. 1C shows a radio communication device 118 according to various embodiments. The radio communication device 118 may include a receiver 120 configured to receive scheduling information for a page (in other words: page scheduling information). The page may include one or more segments of a Traffic Indication Map (TIM). Each of the TIM segments may include one or more bits. Each bit may indicate whether there is buffered data at an access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, the receiver 120 may be configured to receive the page scheduling information in a beacon which includes a segment count information element.

According to various embodiments, the page scheduling information may include or may be an indication of the next target transmission time of the beacon that carries a segment count information element for the current page (in other words: for the associated page).

According to various embodiments, the page scheduling information may include or may be an indication of an offset between the beacon that carries the first segment of the page and the current beacon that carries the page scheduling information for the associated page.

According to various embodiments, the page scheduling information may be used to determine the lifetime of buffered frames for a station.

According to various embodiments, the page scheduling information may include or may be an indication of a number of traffic indication map blocks being scheduled for the page.

According to various embodiments, the page scheduling information may include or may be an indication of number of beacon intervals between successive beacons that carry a segment count information element for the associated page.

According to various embodiments, the page scheduling information may include or may be an indication of a number of beacon intervals between successive beacons that carry a segment count information element for the page segment.

According to various embodiments, the page scheduling information may include or may be an indication of a number of beacons before the next beacon that carries a segment count information element.

According to various embodiments, the page scheduling information may include or may be an indication of a scheduling of segments within each segmentation interval.

According to various embodiments, the page scheduling information may include or may be an indication of a page segment length in number of blocks used for the traffic indication map segmentation.

According to various embodiments, the page scheduling information may include or may be an indication of a page segment length.

According to various embodiments, the radio communication device 122 may be configured to wake up based on its page scheduling information.

According to various embodiments, the radio communication device 122 may be configured to wake up independent from its page number.

According to various embodiments, the radio communication device 122 may be configured according to IEEE 802.11ah, for example it may be a STA.

FIG. 1D shows a flow diagram 128 illustrating a method for controlling an access point according to various embodiments. In 130, scheduling information for a page (in other words: page scheduling information) may be transmitted. The page may include one or more segments of a Traffic Indication Map (TIM). Each of the TIM segments may include one or more bits, each bit indicating whether there is buffered data at the access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, the page scheduling information may be transmitted in every beacon which includes a segment count information element.

According to various embodiments, the page scheduling information may include or may be an indication of the next target transmission time of the beacon that carries a segment count information element for the associated page (in other words: for the current page).

According to various embodiments, the page scheduling information may include or may be an indication of an offset between the beacon that carries the first segment of the page and the current beacon that carries the page scheduling information for the associated page.

According to various embodiments, the page scheduling information may be used to determine the lifetime of buffered frames for a station.

According to various embodiments, the page scheduling information may include or may be an indication of a number of traffic indication map blocks being scheduled for the page.

According to various embodiments, the page scheduling information may include or may be an indication of number of beacon intervals between successive beacons that carry a segment count information element for the associated page.

According to various embodiments, the page scheduling information may include or may be an indication of a number of beacon intervals between successive beacons that carry a segment count information element for the page segment.

According to various embodiments, the page scheduling information may include or may be an indication of a number of beacons before the next beacon that carries a segment count information element.

According to various embodiments, the page scheduling information may include or may be an indication of a scheduling of segments within each segmentation interval.

According to various embodiments, the page scheduling information may include or may be an indication of a number of blocks used for the traffic indication map segmentation.

According to various embodiments, the page scheduling information may include or may be an indication of a page segment length.

According to various embodiments, the access point may be configured according to IEEE 802.11ah.

FIG. 1E shows a flow diagram 132 illustrating a method for controlling a radio communication device according to various embodiments. In 134, scheduling information for a page (in other words: page scheduling information) may be received. The page may include one or more segments of a Traffic Indication Map (TIM). Each of the TIM segments may include one or more bits. Each bit may indicate whether there is buffered data at an access point to be transmitted to a respective pre-determined radio communication terminal associated with the access point. The scheduling information may include at least one of the following information: an explicit indication of an interval of one or more recurrences of subsequent transmissions of the scheduling information for the page; or information indicating scheduling of transmission of segments of the page including at least: an offset between the transmission of the first segment included in the page scheduling and the transmission of the scheduling information; and the number of blocks in each segment of the page, wherein a block contains a pre-determined number of bits of the TIM.

According to various embodiments, the page scheduling information may be received in a beacon which includes a segment count information element.

According to various embodiments, the page scheduling information may include or may be an indication of the next target transmission time of the beacon that carries a segment count information element for the associated page (in other words: of the current page).

According to various embodiments, the page scheduling information may include or may be an indication of an offset between the beacon that carries the first segment of the page and the current beacon that carries the page scheduling information for the associated page.

According to various embodiments, the page scheduling information may be used to determine the lifetime of buffered frames at the access point for a station associated with the access point.

According to various embodiments, the page scheduling information may include or may be an indication of a number of traffic indication map blocks being scheduled for the page.

According to various embodiments, the page scheduling information may include or may be an indication of number of beacon intervals between successive beacons that carry a segment count information element for the associated page.

According to various embodiments, the page scheduling information may include or may be an indication of a number of beacon intervals between successive beacons that carry a segment count information element for the page segment.

According to various embodiments, the page scheduling information may include or may be an indication of a number of beacons before the next beacon that carries a segment count information element.

According to various embodiments, the page scheduling information may include or may be an indication of a scheduling of segments within each segmentation interval.

According to various embodiments, the page scheduling information may include or may be an indication of a page segment length in number of blocks used for the traffic indication map segmentation.

According to various embodiments, the page scheduling information may include or may be an indication of a page segment length.

According to various embodiments, the radio communication device may wake up based on its page scheduling information.

According to various embodiments, the radio communication device may wake up independent from its page number.

According to various embodiments, the radio communication device may be configured according to IEEE 802.11ah, for example the radio communication device may be a STA.

Each bit in the traffic indication map may correspond to one particular STA. When the bit is set to 1, it may indicate that there is data buffered in the AP for the corresponding STA. When the bit is 0, it may indicate that there is no data buffered in the AP for the corresponding STA.

TIM encoding and segmentation may be provided for IEEE 802.11ah to support a large number of devices. The encoding may divide the entire TIM bitmap into a plurality of pages, for example into up to 4 pages. Each page may include a plurality of blocks, for example may consist of up to 32 blocks, and each block may include a plurality of AIDs (association identifiers), for example may contain at most 64 AIDs. Based on the hierarchical TIM structure, each Beacon may carry a fixed-sized TIM segment. The segmentation scheduling may be carried in an IE (information element), which may be called the Page Segment Count IE (PSC-IE) or Segment Count IE (SC-IE) It will be understood that PSC-IE and SC-IE are alternative names for the same IE. When the TIM is divided into multiple pages and segmented into different Beacon intervals, a STA may desire to listen to one or more Beacons to synchronize to its designated segment. To synchronize to its segment, a STA may desire to know not only its PSC-IE, but also the scheduling of pages.

According to various embodiments, each Beacon that carries the PSC-IE (a Beacon that carries the PSC-IE may also be called anchor Beacon) may also carry the Page Scheduling information. In this way, any STA needs to listen to a maximum of two Beacons to synchronize to its own anchor Beacon that carries PSC-IE for the STA. Each Beacon may convey the anchor Beacon period and the segment count information so that a STA can synchronize to the next anchor Beacon (which may not necessarily be its own). The anchor Beacon may include the Page Scheduling information, based on which a STA can lock onto its own anchor Beacon.

According to various embodiments, TIM segmentation enhancement may be provided.

FIG. 2 shows an illustration 200 of an example for scheduling and synchronization with anchor Beacons according to various embodiments. A plurality of beacons are shown. For example, a first anchor beacon 202, a second anchor beacon 206, a third anchor beacon 210, and a fourth anchor beacon 214 are shown. Furthermore, further beacons 204, 208, and 212 are shown. The arrows shown in FIG. 2 indicate the beacons that the STA needs to wake up and listen to in order to find its TIM segment. Each anchor beacon may have page scheduling information and page segment count information, and may carry a schedule of subsequent pages. If the number of Beacons between any pair of adjacent anchor Beacons is equal, the Page Scheduling info carried in each anchor Beacon may include the sequence of following pages. The sequence may cover each page at least once so that a STA (station) can always lock on to its own anchor Beacon. The AP (access point) may indicate the size of the sequence in the beginning of the Page Scheduling information. In case that the page transmissions are ordered sequentially, the sequence is fixed, and AP only needs to indicate the total number of pages in the Page Scheduling information. The number of segment for each page can be known from the PSC-IE or can be indicated by AP. In FIG. 2, P1 may indicate the first page, P2 the second page, P3 the third page, and P4 the fourth page. S1 may indicate a first segment, and S2 may indicate a second segment.

If the numbers of Beacons between adjacent pairs of anchor Beacons are different, the Page Scheduling may include the sequence of the following pages and the sequence may cover every page at least once. Besides, the Page Scheduling may also indicate the total number of segments in each of the corresponding page, or the number of Beacons between adjacent anchor Beacons. Alternatively, the AP may indicate the corresponding offset between anchor Beacons.

FIG. 3 shows an illustration 300 of fast synchronization to an anchor Beacon according to various embodiments. For example, a first anchor beacon 302, a second anchor beacon 306, a third anchor beacon 310, and a fourth anchor beacon 314 are shown. Furthermore, further beacons 304, 308, and 312 are shown. The arrows shown in FIG. 3 indicate the beacons that the STA needs to wake up and listen to in order to find its TIM segment.

Each anchor beacon may include a segment count information element, and may carry the Page Scheduling information. In this way, any STA needs to listen to a maximum of one Beacon to synchronize to its own PSC-IE.

Each Beacon may include the PSC-IE period (or the number of Beacons between adjacent anchor Beacons) and the segment count (current segment index) information so that a STA can calculate the offset T₀ (in number of Beacon intervals) from the current Beacon to the next Beacon that carries the PSC-IE (anchor Beacon). Based on TIM, STA knows the current segment index. STA may also know the size of the segment from the TIM bitmap, and the STA may calculate the total number of segments in current page as:

Total number of segments=size of page/size of segment.

Each Beacon may also contain the Page Scheduling information that indicates the number of segments Sᵢ in page i. Each segment may correspond to one Beacon. So Sᵢ may have the same unit as T₀. A STA may calculate the offset Tⱼ (in number of Beacon intervals) from the current Beacon to the j-th Beacon that carries the PSC-IE as:

Tⱼ=T₀+Σᵢ₌₁^{j-1}Sᵢ.

When segmentation is relatively static and fixed over a long period of time, the AP may inform the STA about the Page Scheduling information during (re)association or through management frame exchange. The STA may be able to synchronize to its PSC-IE based on the received Beacon and/or its time synchronization function.

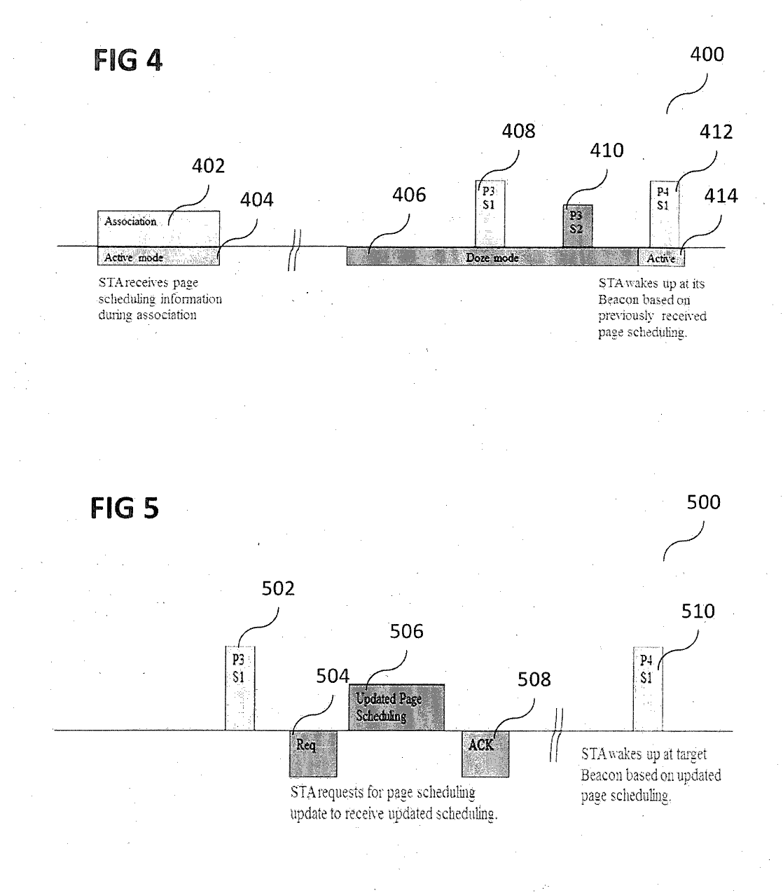

FIG. 4 shows an illustration 400 of an AP informing a STA about the Page Scheduling information duration association 402, during which the STA is in active mode, like indicated by box 404. Then, the STA may be in doze mode (like indicated by box 406) at the time when a first beacon 408 and a second beacon 410 are sent, and may wake up (in other words: may be active, like indicated by box 414) at its beacon 412 based on the previously received page scheduling.

The STA may also request for updated Page Scheduling information if it detects there is a change in the Page Scheduling. The scheduling information update may be immediate (AP sends the updated Page Scheduling to STA in SIFS after STA's request for update) or delayed (AP acknowledges a STA's request for updated Page Scheduling and sends the updated Page Scheduling to the STA later).

FIG. 5 shows an illustration 500 in which a STA requests updated Page Scheduling information (in 504, for example after receiving a beacon 502) upon detection of page scheduling change. The AP responds immediately to Page Scheduling update request in this example (in 506). The STA may acknowledge in 508, and may wake up at the target beacon (in 510) based on updated page scheduling.

Some of the Beacons may also carry DTIM (delivery traffic indication message) information to indicate buffered downlink broadcast/multicast data units. The AP may use one AID (AID 0) to indicate any general downlink broadcast/multicast data.

Buffer status indication for multicast traffic does not need to follow the page segment structure. A DTIM may indicate buffered multicast traffic status for STAs belonging to any page.

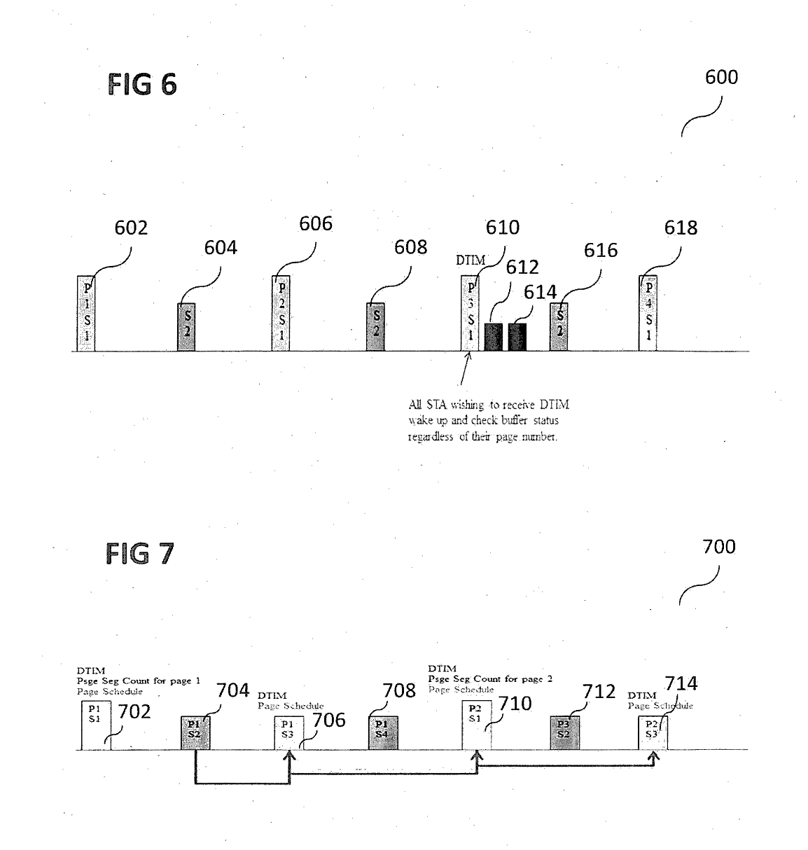

FIG. 6 shows an illustration 600 in which all STAs wish to receive DTIM wake up and check AP buffer status regardless of their page number. A plurality of beacons 602, 604, 606, 608, 610, 616, and 618 are shown. For example, all STAs wishing to receive DTIM may wake up and check buffer state regardless of their page number, like indicated by blocks 612 and 614.

According to various embodiments, the anchor Beacon may be the DTIM Beacon, but this may not always be the case. When the DTIM period is independent of the page segmentation, the DTIM Beacon may not necessarily carry the PSC-IE. Similarly, the PSC-IE Beacon may not be a DTIM Beacon.

In addition to the use of anchor Beacon, the DTIM Beacon may also carry the Page Scheduling information, so that a STA may use the DTIM count and DTIM period to synchronize to a DTIM Beacon and check its Page Scheduling information.

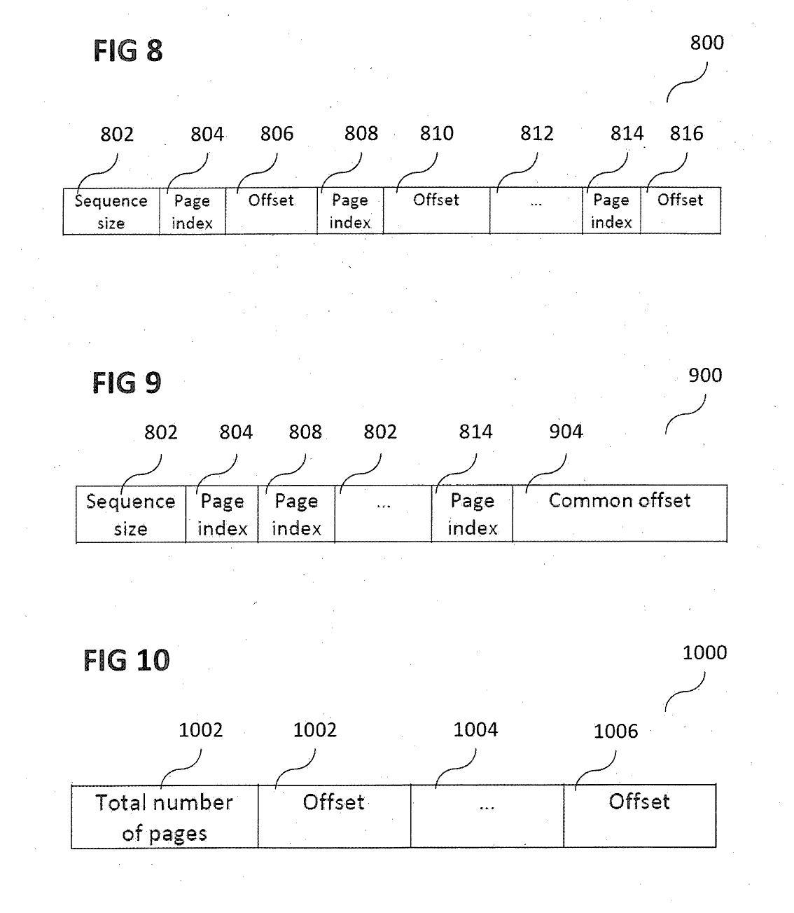

FIG. 7 shows an illustration 700 of a DTIM Beacon carrying the Page Scheduling information. A plurality of beacons 702, 704, 706, 708, 710, 712, and 714 are shown. To support flexible and independent DTIM with segmentation, each Beacon may point to the next DTIM Beacon (like indicated by the arrows in FIG. 7) using DTIM period and DTIM count so that STAs wishing to check buffer status for multicast/broadcast data can synchronize to the DTIM Beacon. Additionally, the Beacon may also point to the next Page Scheduling information, either explicitly or implicitly, so that a STA can synchronize to its own Beacon carrying PSC-IE. 100951 FIG. 8 shows an illustration 800 of a format of the Page Scheduling core information using page index+(and) offset format according to various embodiments. In the Scheduling information format shown in FIG. 8, a sequence size field 802, a page index field 804, an offset field 806, a page index field 808, a further page index field 808, a further offset field 810, further fields (like indicated by dots 812), yet a further page index field 814, and yet a further offset field 816 may be provided.

The page index (e.g. page index=i) may indicate the page number (e.g. i-th page), and the offset may indicate the offset in number of Beacon intervals to the anchor Beacon (or the Beacon that carries the PSC-IE) for page i. The Sequence Size indicates the total number of pages covered in the current Page Scheduling information.

FIG. 9 shows an illustration 900 of a Page Scheduling information format according to various embodiments. Various fields shown in FIG. 9 may be identical or similar to fields shown in FIG. 8, so that the same reference signs may be used and duplicate description may be omitted. Further page indices may be present, like indicated by a field 902 with dots. When the offsets between adjacent anchor Beacons are equal, the AP may use the simplified format as shown in FIG. 9, where the page sequence is indicated with a common offset (like indicated in a common offset field 904) between anchor Beacons for the pages.

FIG. 10 shows an illustration 1000 of a page scheduling information format according to various embodiments, in which a total number of pages field 1002, and a plurality of offset fields 1002, 1004, 1006 are provided. When the pages are always transmitted sequentially, the page scheduling may be further simplified as shown in FIG. 10. The AP first may indicate the total number of pages. Based on the knowledge of current page index (either explicitly indicated by AP or conveyed in other field such as TIM), the STA may be able to match the offset with its corresponding anchor Beacon.

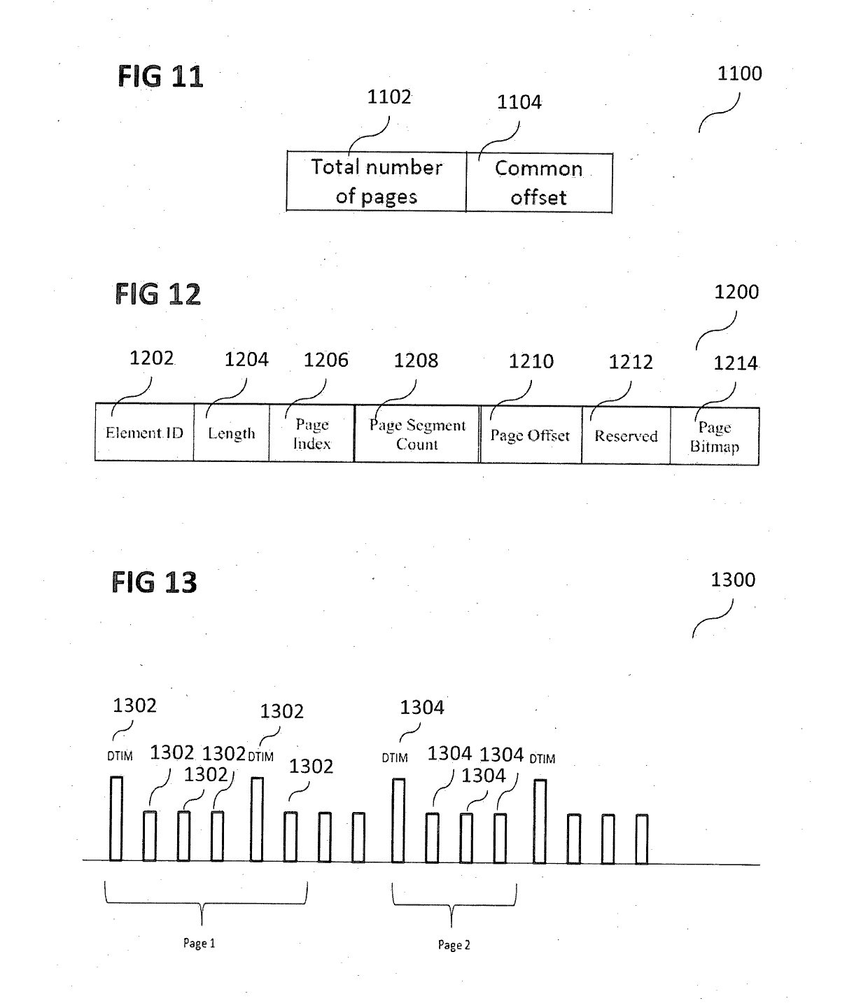

FIG. 11 shows an illustration 1100 of a page scheduling information format according to various embodiments, in which a total number of pages field 1102 and a common offset field 1104 are provided. When the offsets between adjacent anchor Beacons are equal and page transmission is sequential, the Page Scheduling may be further simplified as shown in FIG. 11, where the offsets are now equal and indicated by a common offset.

Based on the implementation, the AP may choose one of the above formats for Page Scheduling information indication. AP may also support multiple encoding formats by indicating the format type. Besides the core information conveyed in the above formats, AP may indicate other information to facilitate a STA to synchronize to the anchor Beacon. For example, if the Page Scheduling information is carried in every Beacon, AP may also indicate the offset from current Beacon to the next anchor Beacon. AP may also indicate the current page number if TIM IE is not present.

According to various embodiments, TIM and Page Segment for Non-TIM STAs may be provided.

A non-TIM STA may not be required to listen to the beacon before transmitting PS-Poll/Trigger frame:
a non-TIM STA may be required to send PS-Poll/Trigger frame at least once in one listen interval.

A non-TIM STA may be re-synchronized with next beacon by AP's response to its PS-Poll/Trigger frame:
The AP should indicate to non-TIM STA for its downlink buffered data in TIM page/segment;
TIM page/segment for non-TIM STA may be unscheduled and may not be determined by Segment Count IE in DTIM due to Segment Count IE usually considers only TIM STA.

According to various embodiments, the indication may be included in TIM and page segment for non-TIM STA.

There may be two cases like will be described in the following.

In a first case (which may also be referred to as case 1), both TIM and non TIM STAs may be associated with the same AP:

In case 1a, AID (re)assignment protocol may be used to move all non-TIM STAs into separate page/segment: Segment Count IE may only consider the pages/segments for TIM STAs.

In case 1b, TIM and non-TIM STAs may share the same AID space: Segment Count IE may include the pages/segments for non-TIM STAs.

In a second case (which may also be referred to as case 2), all STAs associated with the same AP may be in non-TIM mode: There may be no Segment Count IE in DTIM. Therefore, according to various embodiments, devices and methods may be provided for the following cases:

In case 1a, no change may be required for segment count IE but its corresponding TIM page segment may exclude non-TIM STA. It may be desired to include non-TIM STA in separate page segments; it may be inflexible when the number of TIM and non-TIM STAs changes dramatically.

In case 1b, no change may be required for segment count IE. It may be less favorable for slot assignment/TIM indication but without overhead of AID reassignment.

Case 2 may require to include non-TIM STA in page segments. Slot assignment based on TIM IE may only consider paged STAs as non-paged STA is not meaningful in this case.

As the AP may respond to the unscheduled (NDP) PS-Poll/trigger frame sent by the non-TIM STAs with a timer/time indication pointing to the transmission time of the beacon which carries the information of the bitmap of traffic indication for the STAs in the multiple pages, according to various embodiments, the AP may include the traffic indication for all mode-switching non-TIM STAs in multiple pages into either one or a few TIM IEs for the beacon.

According to various embodiments, TIM and page segment may include the traffic indication for non-TIM STA if non-TIM STA is switched to TIM mode temporarily.

To facilitate the operation of TIM and page segmentation, AIDs of non-TIM STAs and TIM STAs may be always separated into exactly two non-interleaving ranges if their AID space in one TIM page is separated. If separated page segments for TIM or non-TIM STAs in one page are interleaved, it may be difficult to support varying length of page segment in multiple DTIM beacon intervals and use segment count IE to indicate the segments efficiently.

Due to TIM IE includes the bitmap for 1^{st} page segment in DTIM element, it may be redundant to include 1^{st} page segment in page bitmap field in Segment Count IE. It may be straightforward to know the starting block index by decoding 1^{st} AID bit in the TIM bitmap.

The field of page bitmap in Segment Count IE may exclude the blocks in 1^{st} page segment in DTIM element, where
Page Offset (for example 5 bits, which may be dependent on block size) field indicating the first block in second assigned page segment in DTIM element; and
Page Bitmap (for example 0-4 octets, which may be dependent on block size) field for blocks of all page segments excluding 1^{st} page segment in DTIM element.

Page offset and Page segment count fields in the segment count IE may indicate initial block offset and range of TIM element in each TIM segment. The following may only be applicable to TIM segment number>1:

Block offset/start=page offset+((length of page segment)*(TIM segment number−1))+1; and

Block Range=page offset+(length of page segment)*(TIM segment number).

For 1^{st} TIM segment, block offset/start may be obtained through TIM IE and block range can be obtained by the following equation:

page offset+(length of page segment)*(TIM segment number)−1.

In case 1a, if TIM page segments are applied for TIM STAs only, it may be required to include non-TIM STA in separate page segment(s). The page segment for non-TIM STAs may not be considered as regular page segment. Segment count IE may or may not include into page bitmap field the bitmap block to which this non-TIM STA belongs. Slot assignment based on TIM IE may include non-TIM STA when it temporarily switches its mode.

In a case 1b, if TIM page segments are applied for both TIM and non-TIM STAs, Non-TIM STA may re-synchronize with the transmission time of the beacon carrying its TIM page segment (not necessary next TBTT (Target Beacon Transmission Time)). Slot assignment based on TIM IE may not be valid for the case that paged and unpaged STAs are allowed to access RAW. To avoid the confusion with non-paged and non-TIM STAs to infer the assigned slot, TIM encoding based on AID differential encoding may be used.

In an Option 2a of a case 2, if TIM page segments are applied for non-TIM STAs, segment count IE may be used for mode-switching non-TIM STAs. The AP may include a time indication in the response to non-TIM STA's PS-Poll/Trigger frame and the indicated time points to DTIM beacon frame transmission time. Non-TIM STA may go to sleep if the TIM segment is not assigned to itself. Non-TIM STA may wake up on its TIM segment to check its traffic indication (TIM bit) after receiving the DTIM beacon frame including segment count IE. The STA may have to wake up twice to receive its segment. AID reassignment may be required if TIM mode change is allowed and case 1a is applied.

In an option 2b of case 2, if TIM page segments are not applied for non-TIM STAs, segment count IE may not be used for mode-switching non-TIM STAs. The AP may include a time indication in the response to non-TIM STA's PS-Poll/Trigger frame and the indicated time points to beacon frame/TIM/Resource Allocation Frame transmission time. A non-TIM STA may wake up to receive the beacon on the indicated time to check its traffic indication (TIM bit) after receiving the time indication. A non-TIM STA may wake up to receive the Resource Allocation frame on the indicated time to check its traffic indication (TIM bit) and/or its assigned time slot after receiving the time indication.

FIG. 12 shows an illustration 1200 of the format of PSC-IE. The element ID 1202 and length fields 1204 may enable a STA to identify the PSC-IE. The page index 1206 may indicate the page currently assigned to Beacon. The page segment count 1208 may indicate the number of TIM segment for the page. The page offset 12010 may indicates the index of the first block in assigned TIM segment. A reserved field 1212 may be provided. The page bitmap 1214 may enable power-saving for STAs whose TIM segment contains no set bits. The first TIM segment is transmitted in the same Beacon that carries the PSC-IE. The Beacon is normally the DTIM Beacon. A TIM-STA has to first listen to PSC-IE to find out the TIM segmentation scheme and segment schedule. It needs to calculate the number of TIM blocks per segment by:

Number of TIM blocks=number of bits in page bitmap/page segment count.

It may then listen to its corresponding TIM segment to check availability of downlink buffered data at AP.

There may be several issues with the designs of TIM segmentation. The DTIM period may be increased as it has to cater for the maximum number of TIM segments. As an example, to cater for TIM segmentation, DTIM period may be as long as 32 Beacon intervals. However, this may cause delay in delivery of buffered broadcast data, which may be indicated by DTIM Beacon. Assuming typical Beacon interval of 100 ms, a DTIM period of 32 causes delay more than 3 sec, which may be highly undesirable for some applications. Another issue with the designs may be that some Beacons may not carry the TIM IE, as DTIM period has to cater for the maximum number of TIM segments. This may happen, for example, when page 1 is segmented into 32 segments, whereas page 2 is only segmented to 8 segments. In this case, the remaining 24 Beacons in page 2 are empty. This may cause delay for subsequent TIM segments (for example of page 2), and may be undesirable. The above issues may arise because DTIM period may be determined based on TIM segmentation. Hence, the above issues may be mitigated if the DTIM period may be made independent of TIM segmentation. Furthermore, STAs in different pages may have different QoS requirement. For example, STAs in page 1 may be less delay tolerant, whereas STAs in page 2 may be more delay tolerate. In this case, the pages need not be transmitted in sequence, but may cater for the different QoS requirements. According to various embodiments, devices and methods may be provided which address the above issues; for example, new TIM segmentation schemes may be provided.

FIG. 13 shows an illustration 1300 of a TIM segmentation scheme according to various embodiments. In this scheme, the first segment of a page is always carried in the DTIM Beacon. The DTIM Beacon that carries the first TIM segment of a page also carries the PSC-IE for the page. An example of the TIM segmentation scheme is shown in FIG. 13. The DTIM period may be 4. Page 1 may be segmented into 6 TIM segments (each one labeled as 1302), and page 2 may be segmented into 4 TIM segments (each one labeled 1304). The first TIM segment is always transmitted in DTIM Beacon, which also carries the PSC-IE. For other DTIM Beacons that do not carry the first TIM segment, they may not carry the PSC-IE. Page 1 and Page 2 TIM segments may also be transmitted on the same Beacon.

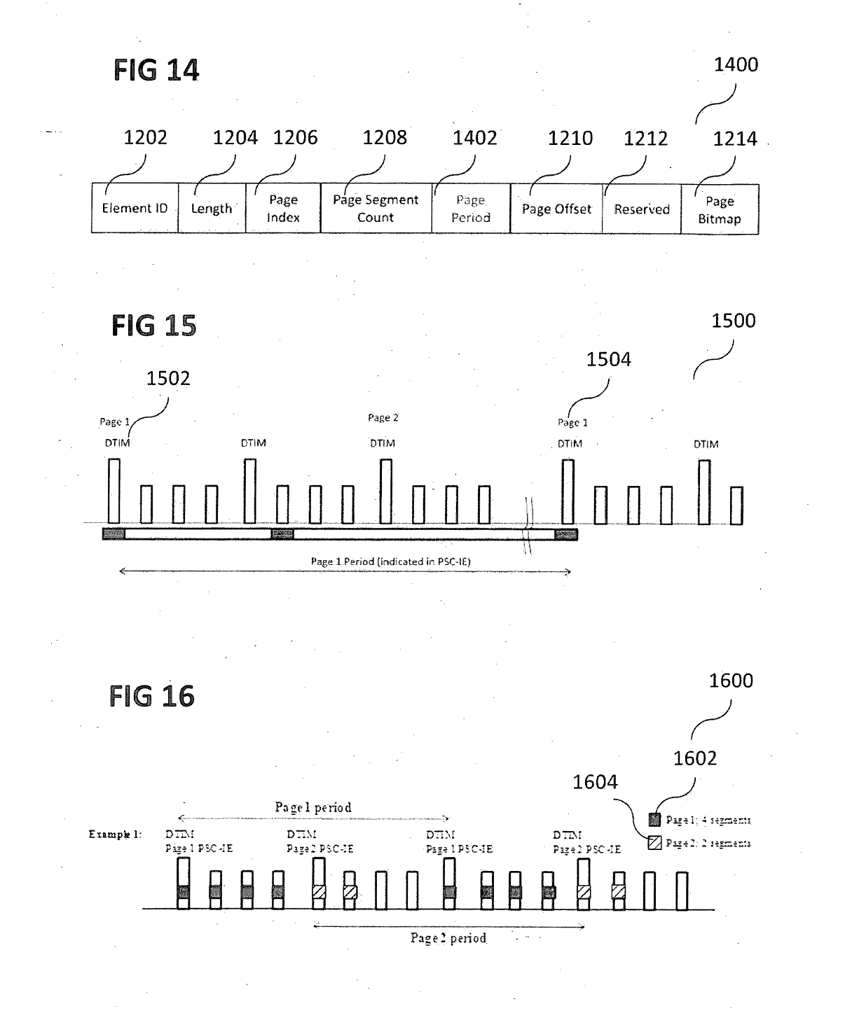

FIG. 14 shows an illustration 1400 of a PSC-IE format according to various embodiments. Various fields shown in FIG. 14 may be similar or identical to fields shown in FIG. 12, so that the same reference signs may be used and duplicate description may be omitted. The AP may indicate the next target transmission time of the Beacon that carries the PSC-IE for current page. The format according to various embodiments is shown in FIG. 14, where a ‘page period’ field 1402 is added to the PSC-IE. The page period may indicate the target time at which the next DTIM Beacon that carries the PSC-IE for current page will be transmitted. The target transmission time may be indicated in unit of Beacon interval, or in unit of DTIM period.

FIG. 15 shows an illustration 1500 of a TIM segmentation with page period indication according to various embodiments. The STA may calculate the TBTT of the next Beacon that carries the PSC-IE for its own page, and may wake up to receive the Beacon. The STA may receive the PSC-IE for page 1 (indicated by 1502) from the DTIM Beacon. The PSC-IE indicates the schedule of TIM segments, and also the target time of the next Beacon that carries the PSC-IE for page 1, where the STA may later wake up to receive (indicated by 1504). The STA may then wake up at the corresponding Beacon to check TIM segment. It then goes to sleep mode and wakes up again at the DTIM Beacon as indicated by the earlier PSC-IE.

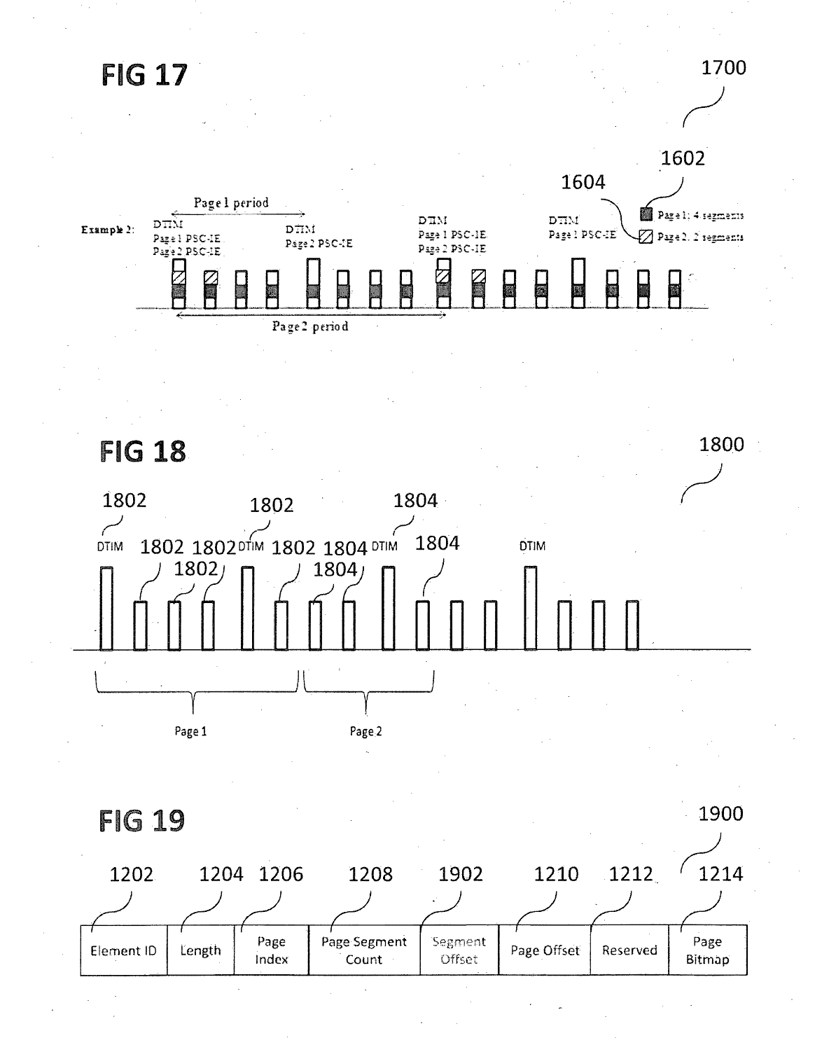

FIG. 16 and FIG. 17 show illustrations 1600 and 1700 of operating examples of periodic pages according to various embodiments, in which page 1 segments are illustrated by a filled box 1602, and page 2 segments are illustrated by a hatched box 1604. The advantage of the method according to various embodiments is that is allows flexible TIM segmentation which is not solely determined by the DTIM period, as shown in FIG. 16 and FIG. 17. The only requirement of the method according to various embodiments is that the PSC-IE may be transmitted periodically. It may allow more frequent DTIM transmission to reduce broadcast latency, and transmission of TIM segments of a page may span across multiple DTIM periods.

FIG. 18 shows an illustration 1800 of a TIM segmentation scheme according to various embodiments. The DTIM period may be 4. Page 1 may be segmented into 6 TIM segments (each one labeled as 1802), and page 2 may be segmented into 4 TIM segments (each one labeled 1804). In this scheme, the first TIM segment of a page may not be transmitted in DTIM Beacon. The PSC-IE may still be carried in DTIM Beacon. The STA needs to listen to the Beacon that carries the PSC-IE for its page to find its TIM segment. As the first TIM segment is not always transmitted in the Beacon that carries the PSC-IE, the AP needs to indicate the offset from the Beacon that carries the PSC-IE to the Beacon that carries the first TIM segment.

FIG. 19 shows an illustration 1900 of a PSC-IE format according to various embodiments. Various fields shown in FIG. 19 may be similar or identical to fields shown in FIG. 12, so that the same reference signs may be used and duplicate description may be omitted. According to various embodiments, a segment offset field 1902 may be added in the PSC-IE to indicate the offset between the Beacon that carries the first segment of the page and the current Beacon that carries the PSC-IE. This may enable the AP to delay the transmission of TIM segments, and also may enable a STA to synchronize to its TIM segment. It will be understood that this embodiment may be combined with other embodiments described herein. For example, the AP may also add the page period field as described above in the PSC-IE so that a STA can know when to wake up again to receive the next PSC-IE.

According to various embodiments, an offset indication may be added in DTIM beacon to indicate the target transmission time of the Beacon that carries PSC-IE. This may help the STA to find PSC-IE for its page, and allows decoupled TIM segmentation and DTIM operation.

A STA may have to listen to PSC-IE first to find the TIM segmentation scheme for its page. The TIM segment of the STA may not be carried in the same Beacon as the current Beacon that carries the PSC-IE. Hence, the STA may need to listen to another Beacon that carries its TIM segment, as indicated in PSC-IE. However, for STAs whose TIM segment is carried by the same Beacon that carries the PSC-IE, they only need to receive a single Beacon to know their TIM bit status. This may be unfair if certain TIM segment is always transmitted on the same Beacon as the Beacon that carries the PSC-IE. To mitigate the fairness issue, the AP may rotate the TIM segment in turn such that different segments may have similar chances of being transmitted on the same Beacon that carries the PSC-IE.

According to various embodiments, a ‘start of segment’ and ‘total segment’ indication may be added in the PSC-IE. The ‘start of segment’ may indicate the index of the first segment, which is transmitted on the same Beacon that carries the PSC-IE. The ‘total segments’ may indicate the total number of TIM segment for the page. The value of ‘total segments’ field may be equal to the value of ‘page segment count’ field in the PSC-IE shown in FIG. 12, and the total segment indication field may not necessarily be present. Therefore, using the PSC-IE format shown in FIG. 12, only ‘start of segment’ may need to be indicated, and the total segments is equal to page segment count.

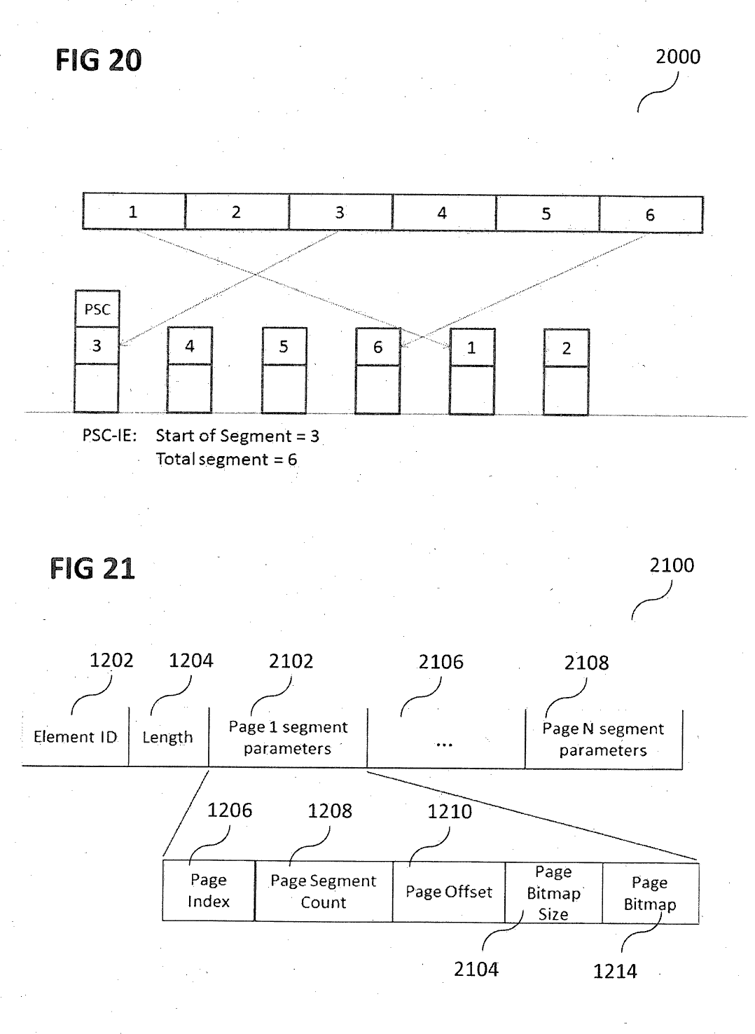

FIG. 20 shows an illustration 2000 of an example of start of segment and total segment indication according to various embodiments, where the TIM is divided into 6 segments. The PSC-IE indicates the start of segment to be 3, which may mean that TIM segment 3 is transmitted first and on the same Beacon that carries the PSC-IE. After that, TIM segment 4, 5, 6, 1, 2 are transmitted.

To reduce the signaling overhead, according to various embodiments, the size of PSC-IE may be reduced by combining multiple PSC-IEs for multiple pages into a single IE, as shown in FIG. 21.

FIG. 21 shows an illustration 2100 of combining multiple PSC-IEs into a single one according to various embodiments, so that fields 2102, 2106, 2108, each for segment parameters of a specific page, may be provided. Various fields shown in FIG. 21 may be similar or identical to fields shown in FIG. 12, so that the same reference signs may be used and duplicate description may be omitted.

A ‘page bitmap size’ field 2104 may be added to indicate the size of the following page bitmap. As all other fields are of fixed size, a STA can determine the total size of segmentation parameters for its page. It will be understood that other fields described herein may also be added.

When the TIM is divided into multiple pages and segmented into different Beacon intervals, a STA needs to listen to one or more Beacons to synchronize to its designated segment. To synchronize to its segment, a STA needs to know not only the PSC-IE for its own page, but also the scheduling of pages. The STA may request for updated Page Scheduling information if it detects there is a change in the Page Scheduling. The scheduling information update may be immediate (AP sends the updated Page Scheduling to STA in SIFS after STA's request for update) or delayed (AP acknowledges a STA's request for updated Page Scheduling and sends the updated Page Scheduling to the STA later). AP may also choose to broadcast the Page Scheduling information in some Beacons. Upon reception of STA's request for Page Scheduling information, AP may defer the STA to listen to the updated Page Scheduling by using a response frame that contains a timer. AP may also defer the STA to its PSC-IE directly with the response frame that contains a timer or an indication of the expected Beacon time. A STA can synchronize to DTIM Beacon with the help of DTIM period and DTIM count information from TIM IE. However, not all DTIM Beacons may carry the PSC-IE if DTIM period is made to be independent of TIM segmentation.

According to various embodiments, an ‘Page Period’ indication may be added in the Segment Count IE. The Page Period may be defined to be the number of beacon intervals between successive beacons that carry the Segment Count IE for the associated page.

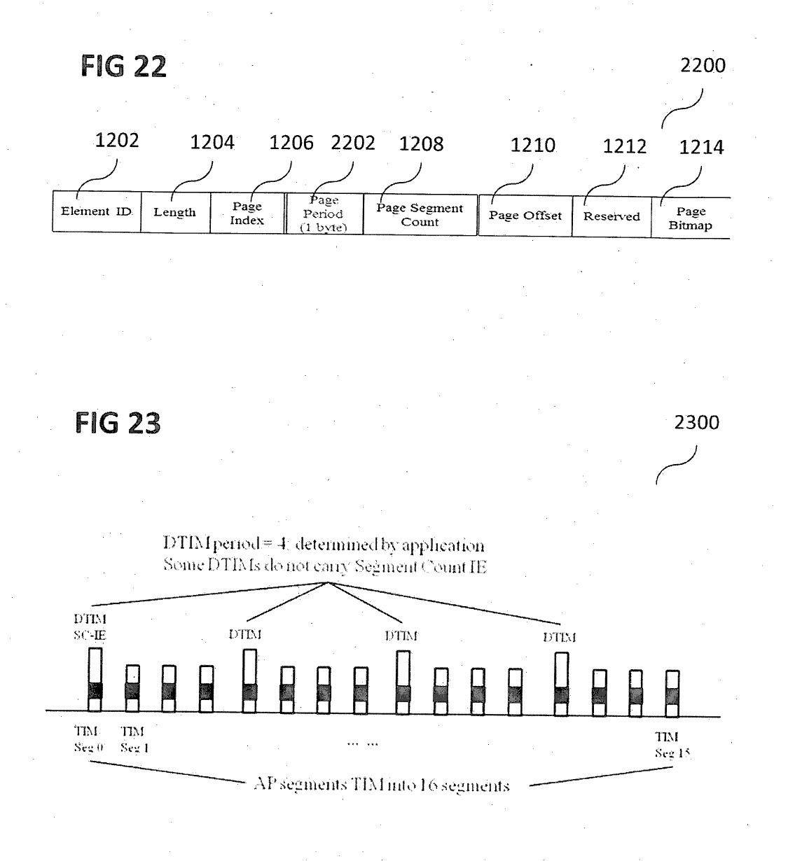

FIG. 22 shows an illustration 2200 of a Segment Count IE with Page Period indication 2202. Various fields shown in FIG. 22 may be similar or identical to fields shown in FIG. 12, so that the same reference signs may be used and duplicate description may be omitted.

The Page Period may be defined in unit of beacon intervals, and it may indicate the number of beacon intervals between the current beacon that carries the Segment Count IE and the immediate next beacon that carries the Segment Count IE for the associated page indicated by Page Index. The definition of Page Period relaxes the constraint that the Segment Count IE must be carried in every DTIM, and allows the Segment Count IE to be carried by any beacon as indicated by the Page Period. The Page Period indication decouples TIM segmentation from DTIM period, and may allow more flexible page scheduling, as shown by the following examples. The page period may alternatively be defined in unit of DTIM periods.

FIG. 23 shows an illustration 2300 of an operating example of TIM segmentation with Page Period indication according to various embodiments. The DTIM period may be 4 beacon intervals, and the Page Period may be 16 beacon intervals. The TIM may be fragmented into 16 segments. The Segment Count IE may not be carried by every DTIM beacon. In this example, it is carried by every 4^{th} DTIM beacon. TIM segmentation may be scheduled every 16 beacons.

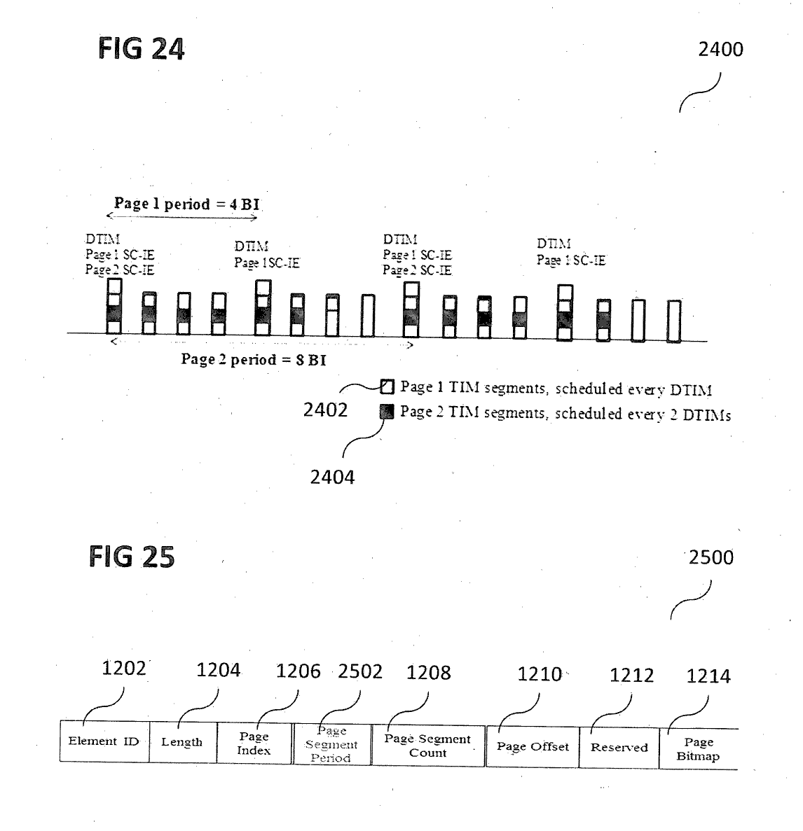

FIG. 24 shows an illustration 2400 of an operating example of TIM segmentation with Page Period indication for two pages according to various embodiments. The DTIM period may be 4 beacon intervals. The Page Period for Page 1 may be 4 beacon intervals, and the Page Period for Page 2 may be 8 beacon intervals. For Page 1, TIM segmentation may be scheduled in every DTIM (like indicated by boxes 2402 filled with light gray), and for Page 2, TIM segmentation is scheduled every two DTIMs (like indicated by boxes 2404 filled black).

It is to be noted that with Page Period indication, the Segment Count IE may also be carried by normal beacons other than DTIM beacons. Whether to signal the Segment Count IE in DTIM beacon or normal beacon is up to AP's implementation of Page Period indication.

The Page Period may define the period for each page. The concept may be generalized to page segment. In other words, each page segment may have its own period, and different page segments may have different periodicity.

According to various embodiments, a ‘Page Segment Period’ may be defined to be the number of beacon intervals between successive beacons that carry the Segment Count IE for the page segment. The Page Segment Period is indicated in the Segment Count IE as shown in FIG. 25.

FIG. 25 shows an illustration 2500 of Page Segment Period 2502 (in other words: a page segment period field 2502) in Segment Count IE. Various fields shown in FIG. 25 may be similar or identical to fields shown in FIG. 12, so that the same reference signs may be used and duplicate description may be omitted.

The range of page segment may also be indicated in the Segment Count IE (either based on current method or enhanced signaling). Based on current Segment Count IE, the range of page segment may be indicated by the Page Offset and Page Bitmap in Segment Count IE. Alternatively, enhanced signaling may be used to indicate the range of page segment, such as explicitly indicating the start and end of block index in the page segment, or the start block index and length of block range.

A STA may have to listen to SC-IE first to find the TIM segmentation scheme for its page. The TIM segment of the STA may not be carried in the same Beacon as the current Beacon that carries the SC-IE. Hence, the STA may need to listen to another Beacon that carries its TIM segment, as indicated in SC-IE. However, for STAs whose TIM segment is carried by the same Beacon that carries the SC-IE, they only need to receive a single Beacon to know their TIM bit status. This will be unfair if certain TIM segment is always transmitted on the same Beacon as the Beacon that carries the SC-IE. To improve the fairness in STA power saving, AP may randomize the mapping between TIM segment and page segment such that different segments may have similar probability of being transmitted on the same Beacon that carries the SC-IE.

According to various embodiments, the AP may determine the total number of TIM segments N_{TIM}, which is equal to the total number of page segments indicated by the Page Segment Count field. The ordered page segments are indexed sequentially from 1 to N_{TIM}, The ordered TIM segments are indexed sequentially from 0 to (N_{TIM}−1), where the TIM segment with index 0 corresponds to the DTIM that carries the Segment Count element. The AP may determine the index of the TIM segment to assign the pth page segment based on the following mapping function:

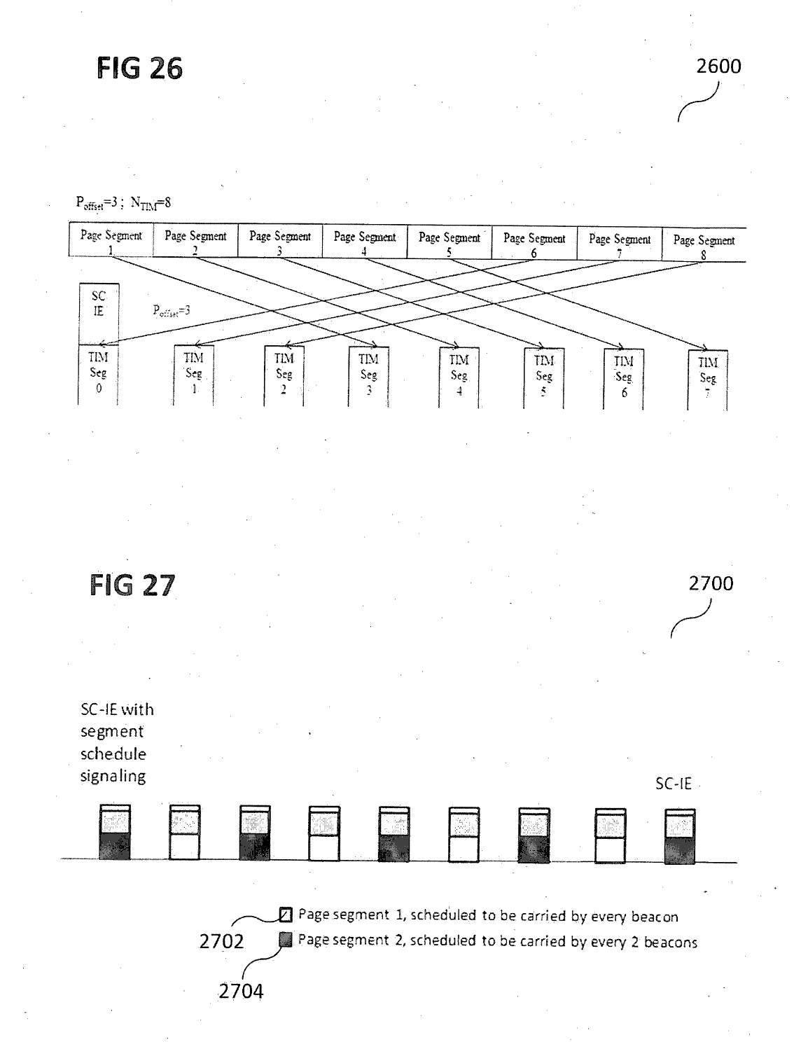

i_{TIM}=(p+P_{offset}−1)mod N_{TIM}

where i_{TIM} is the index of the TIM segment that is assigned the p^{th} page segment, mod X denotes the modulo X operation. P_{offset} represents the offset value in the mapping function, which improves the fairness among the STAs, and the two least significant bytes of the FCS field of the Beacon frame shall be used for the P_{offset}. An example with P_{offset}=3 for N_{TIM}=8 is shown in FIG. 26 to illustrate the mapping between page segment and TIM segment.

FIG. 26 shows an illustration 2600 of an example of mapping between page segment and TIM segment for P_{offset}=3 according to various embodiments.

It may be possible that some STAs may lose synchronization with their page. To help these STAs find the beacon that carries their Segment Count IE, the AP may include some signaling in the TIM IE to indicate when the next Segment Count IE will be transmitted.

According to various embodiments, in TIM IE the Page Count may be indicated to help a STA synchronize to its page. The Page Count may indicate the number of beacons before the next beacon that carries the Segment Count IE for the associated page. It may indicate how many beacon frames (including the current frame) appear before the next beacon that carries the Segment Count IE for the associated page. When the value of the Page Count is 0, it indicates the current beacon carries the Segment Count IE for the associated page.

Current TIM segmentation may follow a fixed approach, where the TIM segment range is determined based on the number of blocks indicated in Page Bitmap, the total number of segments indicated by the Page Segment Count, and the Page Offset. Within each TIM segmentation interval (i.e. the interval between two consecutive beacons that carry the Segment Count IE for the same page), each TIM segment is transmitted only once following some predefined sequence. However, different TIM segment may have different QoS requirement. To support different traffic features for different TIM segments, AP may schedule the segments within each TIM segmentation interval.

According to various embodiments, the scheduling of segments may be indicated within each segmentation interval. The indication may either be in the Segment Count IE or in a new IE. When the segment scheduling information is carried in the Segment Count IE, a bit may be used to indicate whether the segmentation is fixed or dynamic. In the case of fixed segmentation, a current TIM segmentation scheme applies. In the case of dynamic segmentation, additional scheduling information may be signaled in the Segment Count IE. Such signaling may indicate the range of TIM segments and the expected beacon or beacons that will carry the TIM segments.

FIG. 27 shows an illustration 2700 of segment scheduling according to various embodiments. The segment scheduling information may signaled in the Segment Count IE. In the example, the page segment 1 is scheduled to be transmitted in every beacon (like indicated by light gray boxes 2702), and the page segment 2 is scheduled to be transmitted every 2 beacons (like indicated by black boxes 2704).

Current TIM segment range may be calculated based on the number of blocks indicated in Page Bitmap, the total number of segments indicated by the Page Segment Count, and the Page Offset. The Page Bitmap can only be integer number of bytes. In other words, the number of blocks in Page bitmap used in the calculation may only be 0, 8, 16, 24, and 32 blocks.

According to various embodiments, a Page Bitmap Length may be indicated in the Segment Count IE. The Page Bitmap Length may indicate the number of blocks used for the current TIM segmentation. So the range of blocks used for the TIM segmentation may be [Page Offset, Page Offset+Page Bitmap Length−1]. The actual Page Bitmap transmitted may be larger than the range of blocks, and the bits in the actual transmitted Page Bitmap outside the range of blocks may be undefined/reserved. For example, they may be considered as padding/trailing bits to make the actual transmitted Page Bitmap an integer multiple of octets.

Page Bitmap Length may imply the number of bytes for the bitmap, which may allow combining multiple Segment Count IEs into a single IE. The number of bytes used for Page Bitmap may be the minimum integer that is greater or equal to Page Bitmap Length indicated in number of blocks divided by 8. In other words, it may be calculated as:

Page Bitmap size(octets)=ceiling(Page Bitmap Length/8).

In the equation above, ceiling(.) may denote ceiling operation. For example, when Page Bitmap Length is 20 (blocks), the Page Bitmap may be 3 octets, with only the first 20 bits as valid indication of buffered data for the 20 blocks and the last 4 bits as undefined/reserved.

The Page Bitmap Length indication may use reserved bits in current Segment Count IE, or adding new bits in the Segment Count IE. Different number of bits indicates the Page Bitmap Length at different resolutions. The Page Bitmap may possibly contain 0 to 32 blocks, and 6 bits may be needed to indicate the exact number of valid blocks in the Page Bitmap. When the number of bits is limited, the granularity of Page Bitmap Length indication may be coarse. Finer indication granularity may require more bits.

According to various embodiments, Page Segment Length instead of Page Segment Count may be indicated in the Segment Count IE, so that the Page Segment Length in each TIM segment is explicitly indicated. The constraint that the segment length for each TIM segment shall be the same may be further relaxed, and this may allow different Page Segment Length in different TIM segments. Signaling TIM segmentation this way may be more flexible, and the total number of TIM segments may be inferred as:

Total number of TIM segments:N=min(S,P)

where
S=ceiling (Page Bitmap Length/Page Segment Length), and
P=number of beacons intervals between successive beacons that carry the Segment Count IE.

In the above calculation, N may be the total number of TIM segments, and ceiling(.) may denote the ceiling operation. P may be the Page Period if it is implemented, or the DTIM period based on current specification. Taking N to be the minimum value of S and P accounts for the situation where the granularity of Page Bitmap Length indication is coarse, and the last few segments may not carry valid page blocks in this case. The segments that do not carry valid page blocks may be truncated by indication of P.

The length of page segment in the first (N−1) segments may be equal to the indicated Page Segment Length, and the length of page segment in the last segment is equal to: Page Bitmap Length−(N−1)*Page Segment Length.

AP and STA may further agree on some algorithm to further balance the load between the first (N−1) TIM segments and the last TIM segment such that the length of page segment in each TIM segment is similar. For example, the page may be segmented such that the length of page segment in the first N_{—}1 TIM segments is P_{—}1, and the length of page segment in the last N_{—}2 TIM segments is P_{—}2 subject to the constraints such that N_{—}1+N_{—}2=N, and N_{—}1*P_{—}1+N2*P_{—}2=Page Bitmap Length, and the difference between P_{—}1 and P_{—}2 should be minimized. It is to be noted that the Page Bitmap Length may be explicitly indicated or implied by the Page Bitmap field.

In the following, AP buffer management will be described.

A STA may indicate its listening interval (LI) to AP during association/reassociation, or later through management frame exchange. When the STA goes into PS mode, AP buffers downlink data for the STA for at least LI to ensure that the STA can wake up to poll the buffered downlink data as indicated by TIM in Beacon before AP drops the buffered data.

When TIM segmentation (e.g. based on TIM Segment Count IE i.e. PSC-IE included in DTIM beacon) is implemented, AP shall buffer the downlink data for a STA in power saving mode for at least T time units in the worst case when TIM segment schedule may be changed over DTIM beacons. T is calculated as:

T=LI+[2*D−2]*BI (Eq. 1)

where LI is the listening interval of the STA in time unit, BI is the Beacon interval in time unit, and D is the DTIM period in number of BIs.

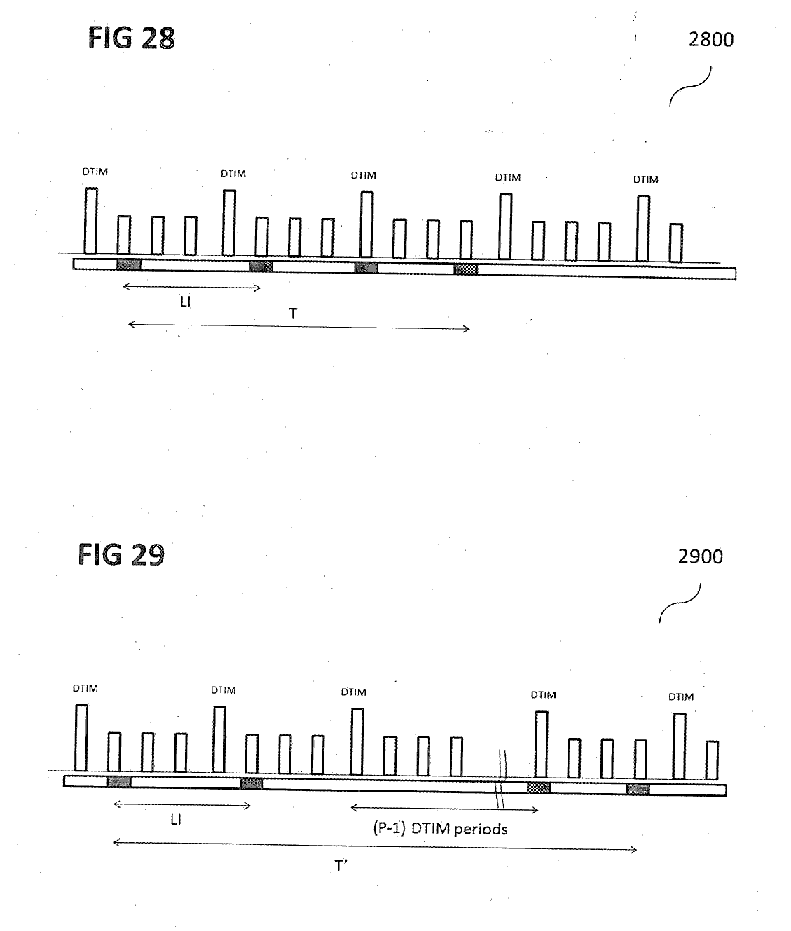

This is illustrated in FIG. 28.

FIG. 28 shows an illustration 2800 of a calculation of T with zero offset between the first TIM segment and the beacon that carries the Segment Count IE of the page.

After receiving buffered downlink data (t=0), a STA wakes up again to check its TIM at t=LI (assume TBTT of the first (most left hand side) DTIM beacon in the figure is 0). However, the Beacon at t=LI does not belong to the STA's TIM segment, and the STA has to listen to the DTIM to find its TIM segment based on PSC-IE. In the worst case, the STA receives the first non-DTIM Beacon after waking up at t=LI, and the STA's TIM segment is scheduled to be the last Beacon of the DTIM period. This yields the worst case delay of (2*D*BI−2*BI).

The above calculation assumes a STA will receive every DTIM. A STA may not need to receive every DTIM Beacon, as in flexible multicast service. In this case, the STA and AP need to setup a DTIM delivery interval P in number of DTIM period, where the STA only wakes up to receive every P^{th} DTIM. In this case, AP has to buffer the downlink data for T′ time units, where

T′=LI+[(P+1)*D−2]*BI. (Eq. 2)

The calculation of T′ is shown in FIG. 29.

FIG. 29 shows an illustration 2900 of a calculation of T′ with zero offset between the first TIM segment and the beacon that carries the Segment Count IE of the page.

However, if the TIM segment schedule is fixed or AP may be able to change the buffering time for the buffered frame, AP shall buffer the downlink data for a STA in PS mode for at least T time units, i.e.

T=[TSeg(i+1)+D−TSeg(i)]*LI, for LI<=D*BI, (Eq. 3)

where TSeg(i) is the DTIM Count value for the TIM segment that the STA belongs to. If the TIM segment is not changed over DTIM beacons,

T=D*LI, for LI<=D*BI. (Eq. 4)

When there is a change for the STA's TIM segment in (i+1)-th DTIM beacon interval, T could be either larger than D*BI or smaller than D*BI.

When LI is larger than D*BI,

T=[TSeg(j+ceil(LI/D*BI),i+1)+D*ceil(LI/D*BI)−TSeg(j,i)]*LI, for LI>D*BI, (Eq. 5)

where TSeg(j,i) is the DTIM Count value of j-th DTIM beacon for the TIM segment that the STA belongs to.

The above AP buffer management can be used for TIM STAs. Since the clock drift may be significant for non-TIM STA, the buffering time at the AP for the buffered frame to the non-TIM STA should be more than listening interval that is used to indicate to AP how long a STA with has power saving duration to be required to transmit a PS-Poll or trigger frame without listening to a beacon. Current 802.11 (IEEE 802.11-2012) requires the accuracy of the TSF timer shall be no worse than ±0.01%. If the clock drift is about 10 ppm, 5 min doze time requires the long sleep STA should wake up 6 ms before the TBTT. Therefore, the calculation of T should factor in this error. Assume the error is E in time unit. For a non-TIM STA with listening interval LI, the buffering time is at least LI+E.

For the fixed virtual TIM segment assignment, Eq. 6 should change to the following:

T=[D*ceil(LI/D*BI)]*LI+E, for LI>D*BI (Eq. 6).

In Eq. 1 to 6 above, the first TIM segment is transmitted in the same beacon that carries the Segment Count IE of the page.

In the following, a lifetime of buffered frame will be described.

The Listen Interval field in Association Request frame is used to indicate to the AP how often a STA with dot11NonTIMModeActivated set to false in power save mode wakes to listen to Beacon management frames or it is used to indicate to AP the duration during which a STA with dot11NonTIMModeActivated set to true is required to transmit at least one PS-Poll or trigger frame.

The value of this parameter is the Listen Interval parameter of the MLMEASSOCIATE.request or MLMEREASSOCIATE.request primitive and is expressed in units of Beacon Interval. The length of the Listen Interval field is 2 octets.

The Listen Interval field in Association Response frame is used to indicate to the STA a value of listen interval different from that in Association Request frame based on AP's buffer management consideration.

An AP may use the Listen Interval information in determining the lifetime of frames that it buffers for a STA.

In Segment Count IE, the following may be provided:
Page Period (8 bits): this field indicates the number of beacon intervals between successive beacons that carry the Segment Count IE for the associated page.
The draft specification include the “TIM offset” field in Segment Count IE to allow AP to indicate the TIM Beacon offset to the DTIM Beacon which carries the segment Count IEs of the pages. The TIM for the first page segment of a specific page can be allocated at the indicated TIM offset to the DTIM. The TIM Segments can be flexibly scheduled for page segments of different pages over beacon intervals.

TIM segmentation (Segment Count IE) is indicated in DTIM beacon so that TIM IE for the STA's page segment may not appear at every beacon.

The Segment Count element indicates assignment of STAs in Page segments corresponding to their assigned TIM segments. STAs within the assigned Page segment wake up at corresponding TIM segment sequentially to receive buffered data from AP and access medium for uplink traffic. In order to wake up at the appropriate TIM segment, the STAs may compute the Page segment assignment to the TIM segments using the length of the Page Bitmap field and the value in the Page Segment Count fields of Segment Count IE. The length of Page segment assigned to each TIM segment is calculated as:

Length of Page segment=the round off or round up value of(Number of blocks in Page Bitmap/Page Segment Count),

where the number of blocks in Page Bitmap is defined from the size of the Page Bitmap field in Segment Count IE and the Page Segment Count field is defined in Segment Count element. Alternatively, the Length of Page segment may be explicitly indicated by the AP. At every TIM segment, the STAs may compute the initial block offset and block range indicated in the segment.

The TIM segment number is obtained from the TIM Segment Number field in the TIM segment.

The number of beacon intervals between successive beacons that carry the Segment Count IE for the associated page is page period (could be different from DTIM beacon interval). The following cases require that STA may listen to the DTIM beacon in an interval short than its listen interval:
If listen Interval is not equal to Page Period, STA may not be able to receive its page segment unless it listens to its Segment Count IE in DTIM beacon;
If listen Interval is equal to Page Period, STA should listen to its Segment Count IE in DTIM beacon to receive its page segment if a dynamic TIM offset is set for its page.

TIM IE for the STA's page segment may not appear at every beacon:
Channel access latency for non-first page segment;
Extra delay is dependent on the STA's page segment number;
TIM offset may relocate first page segment to the beacon other than DTIM beacon.

Two embodiments may be provided to ensure the AP can deliver the buffered frame to the STA without discarding them due to the improper usage of listen interval and lifetime of buffered frame:
Option 1: An AP may use the information of Listen Interval, Segment Count IE (TIM offset and page period) and DTIM period in determining the lifetime of frames that it buffers for a STA;
Option 2: AP sets the lifetime of the buffered frame to Listen Interval but the STA should ensure it can receive its Segment Count IE and page segment so that I can receive the buffered frame before the expiry of its Listen Interval.

In the following, option 1 will be described in more detail.

If TIM segmentation is implemented, AP shall buffer the downlink data for a STA with dot11NonTIMModeActivated (the indication for TIM mode STA) set to false in power save mode for at least T time units in the worst case when TIM segment schedule may be changed over the beacons with Segment Count IE. AP should consider the lifetime of the buffered frame based on the Segment Count IE (page period and TIM offset) and DTIM period in addition to listen interval parameter.

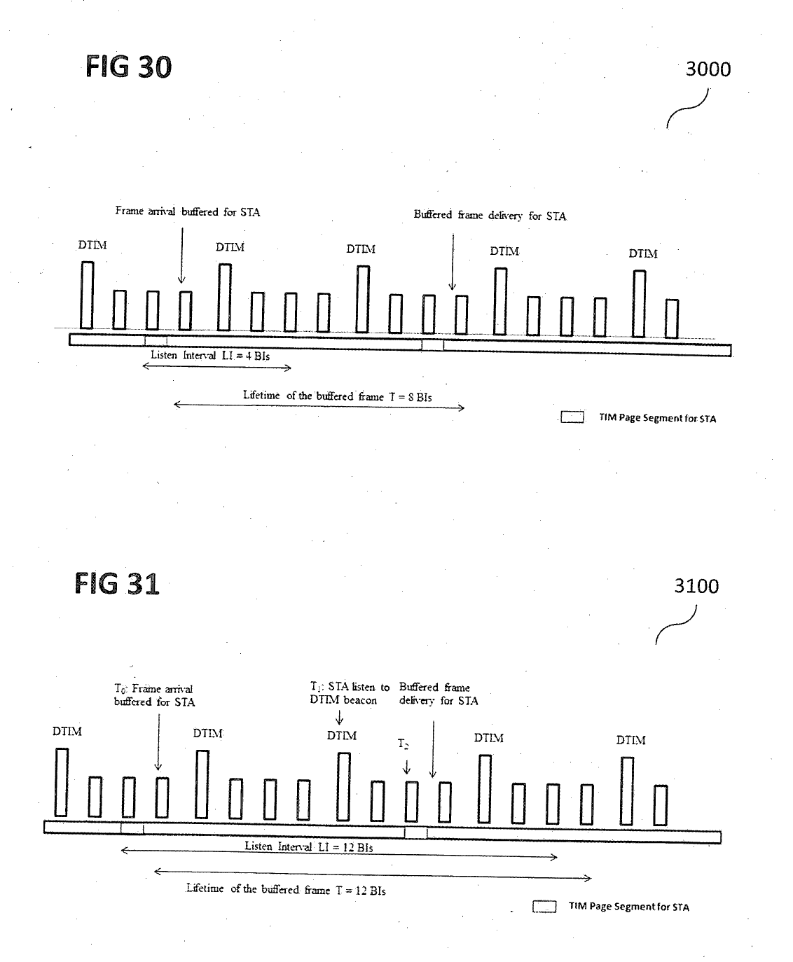

FIG. 30 shows an illustration 3000 of an example of extending the lifetime of buffered frame beyond listen interval.

T can be calculated as: T=LI+T_{off}+(M+N)*BI+T_{D}, where LI is the listening interval of the STA in TU, T_{off} is the duration in TU to the TBTT of the first DTIM beacon carrying the Segment Count IE for the STA's page after the frame has buffered at AP for a period of LI, BI is the Beacon interval in TU, M is TIM offset, N is the page segment number for the STA and D is Page Period value, T_{D} is the buffered frame delivery time after the beacon with STA's page segment. For example, we can set T_{D}=BI.
Since D>M+N, regardless of the dynamics of M and N, we can simplify the lifetime of buffered frame as: T=LI+T_{off}+D*BI+T_{D}.
Since T_{off}<D*BI, regardless of the dynamics of T_{off}, we can simplify the lifetime of buffered frame as: T=LI+2*D*BI+T_{D}.
If T_{D}=BI, T=LI+(2*D+1)*BI.

The above setting of T can ensure the buffered frame is able to be delivered to the STA. This option is applicable to both cases of LI>=STA's page period*BI and LI<STA's page period*BI.

The example illustrated in FIG. 5.1 shows that DTIM period is 4, TIM offset for STA's page segment is 1 beacon interval (BI), STA's page segment number is 1, Listen Interval for the STA is 4 BIs, STA's page period is 8 BIs, T_{off}=1 BI and T_{D}=1 BI. Thus, the lifetime of buffered frame T is 8 BIs.

When AP supports the operation of non-TIM STA, an S1G AP may use the Listen Interval information and Segment Count element and/or DTIM period in determining the lifetime of frames that it buffers for a S1G TIM STA. The information of Page Period, Page index, Page Segment Length, Page Segment Count, Page Offset and TIM Offset in Segment Count element can be used to derive the deferred delivery time for buffered frame after the end of the transmission of DTIM beacon that includes Segment Count IE.

In the following, option 2 will be described in more detail: an alternative option for AP buffer management with TIM segmentation may be that AP sets the lifetime of the buffered frame to Listen Interval but the STA should ensure it can receive its Segment Count IE and page segment so that it can receive the buffered frame before the expiry of its Listen Interval. This option is applicable to the case of LI>=STA's page period*BI.

The latest time T₁ that the STA should listen to its nearest DTIM beacon (i.e. the DTIM beacon with the Segment Count IE for the STA's page) before the expiry of its listen interval, i.e. T₁=T₀+floor((LI−T_{off})/D)*D*BI. If there are page segments, the TBTT for the STA's page segment T₂=T₁+(M+N)*BI. where LI (counted in TU) is the listen interval of the STA, D (counted in the unit of BI) is the page period of the page where the STA is, T₀ is the time of frame buffered at AP, T_{off} is the duration to the TBTT of the first DTIM beacon carrying the Segment Count IE for the STA's page after LI upon the frame is buffered at AP, BI is the beacon interval in TU, M is TIM offset for the STA's page, and N is the STA's page segment number. In fact, the lifetime of buffered frame could be shorter than LI.

FIG. 31 shows an illustration 3100 of an example of a lifetime of a buffered frame equal to a listen interval.

The example illustrated in FIG. 31 shows that DTIM period is 4, TIM offset for STA's page segment is 1 beacon interval (BI), STA's page segment number is 1, Listen Interval for the STA is 4 BIs, STA's page period is 8 BIs, T_{off}=1 BI and T_{D}=1 BI. Thus, the lifetime of buffered frame T is 12 BIs. The STA has to listen to the nearest DTIM beacon at T₁ before the expiry of the listen interval and receive its page segment at T₂. In fact the lifetime of buffered frame for the STA in this example could be shorter, e.g. 8 BIs, if the AP knows the STA will receive its page segment at T₂. If there is no page segmentation change or if Segment Count IE is transmitted in non-DTIM beacons, the STA may be allowed to receive its page segment every page period e.g. at T₂ and without receiving its Segment Count IE at T₁.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An access point comprising:
a transmitter configured to transmit scheduling information for a page,
wherein the page comprises one or more segments of a Traffic Indication Map (TIM); and
wherein each of the TIM segments comprises one or more bits, each bit indicating whether there is buffered data at the access point to be transmitted to a respective pre-determined radio communication terminal associated with the access point; and
wherein the scheduling information comprises at least one of the following information:
an explicit indication of an interval of one or more recurrences of subsequent transmissions of the scheduling information for the page; or
information indicating scheduling of transmission of segments of the page comprising at least:
an offset between the transmission of the first segment included in the page scheduling and the transmission of the scheduling information; and
the number of blocks in each segment of the page, wherein a block contains a pre-determined number of bits of the TIM.

2. The access point of claim 1,
wherein the transmitter is configured to transmit the scheduling information in every beacon which comprises a segment count information element.

3. The access point of any claim 1,
wherein the scheduling information comprises an indication of the next target transmission time of the beacon that carries a segment count information element for the associated page.

4. The access point of claim 1,
wherein the scheduling information comprises an indication of an offset between the beacon that carries the first segment of the page and the current beacon that carries the scheduling information for the associated page.

5. The access point of claim 1,
wherein the scheduling information is used to determine the lifetime of buffered frames for a station.

6. The access point of claim 1,
wherein the scheduling information comprises an indication of a number of traffic indication map blocks being scheduled for the page.

7. The access point of claim 1,
wherein the scheduling information comprises an indication of number of beacon intervals between successive beacons that carry a segment count information element for the associated page.

8. The access point of claim 1,
wherein the scheduling information comprises an indication of a number of beacon intervals between successive beacons that carry a segment count information element for the page.

9. The access point of claim 1,
wherein the scheduling information comprises an indication of a number of beacons before the next beacon that carries a segment count information element for the associated page.

10. The access point of claim 1,
wherein the scheduling information comprises an indication of a scheduling of segments within each segmentation interval.

11. The access point of claim 1,
wherein the scheduling information comprises an indication of a page segment length in number of blocks used for the traffic indication map segmentation.

12. The access point of claim 1,
wherein the scheduling information comprises an indication of a page segment length.

13. The access point of claim 1,
wherein the access point is configured according to IEEE 802.11ah.

14. A radio communication device comprising:
a receiver configured to receive scheduling information for a page,
wherein the page comprises one or more segments of a Traffic Indication Map (TIM); and
wherein each of the TIM segments comprises one or more bits, each bit indicating whether there is buffered data at an access point to be transmitted to a respective pre-determined radio communication terminal associated with the access point; and
wherein the scheduling information comprises at least one of the following information:
an explicit indication of an interval of one or more recurrences of subsequent transmissions of the scheduling information for the page; or
information indicating scheduling of transmission of segments of the page comprising at least:
an offset between the transmission of the first segment included in the page scheduling and the transmission of the scheduling information; and
the number of blocks in each segment of the page, wherein a block contains a pre-determined number of bits of the TIM.

15. The radio communication device of claim 14,
wherein the receiver is configured to receive the scheduling information in a beacon which comprises a segment count information element.

16. The radio communication device of claim 14,
wherein the scheduling information comprises an indication of the next target transmission time of the beacon that carries a segment count information element for the associated page.

17. The radio communication device of claim 14,
wherein the scheduling information comprises an indication of an offset between the beacon that carries the first segment of the page and the current beacon that carries the scheduling information for the associated page.

18. The radio communication device of claim 14,
wherein the scheduling information is used to determine the lifetime of buffered frames for a station.

19. The radio communication device of claim 14,
wherein the scheduling information comprises an indication of a number of traffic indication map blocks being scheduled for the page.

20. The radio communication device of claim 14,
wherein the scheduling information comprises an indication of number of beacon intervals between successive beacons that carry a segment count information element for the associated page.

21. The radio communication device of claim 14,
wherein the scheduling information comprises an indication of a number of beacon intervals between successive beacons that carry a segment count information element for the page segment.

22. The radio communication device of claim 14,
wherein the scheduling information comprises an indication of a number of beacons before the next beacon that carries a segment count information element.

23. The radio communication device of claim 14,
wherein the scheduling information comprises an indication of a scheduling of segments within each segmentation interval.

24. The radio communication device of claim 14,
wherein the scheduling information comprises an indication of a page segment length in number of blocks used for the traffic indication map segmentation.

25. The radio communication device of claim 14,
wherein the scheduling information comprises an indication of a page segment length.

26. The radio communication device of claim 14,
wherein the radio communication device is configured to wake up based on its scheduling information.

27. The radio communication device of claim 26,
wherein the radio communication device is configured to wake up independent from its page number.

28. The radio communication device of claim 14,
wherein the radio communication device is configured according to IEEE 802.11ah.

29. A method for controlling an access point, the method comprising:
transmitting scheduling information for a page,
wherein the page comprises one or more segments of a Traffic Indication Map (TIM); and
wherein each of the TIM segments comprises one or more bits, each bit indicating whether there is buffered data at the access point to be transmitted to a respective pre-determined radio communication terminal associated with the access point; and
wherein the scheduling information comprises at least one of the following information:
an explicit indication of an interval of one or more recurrences of subsequent transmissions of the scheduling information for the page; or
information indicating scheduling of transmission of segments of the page comprising at least:
an offset between the transmission of the first segment included in the page scheduling and the transmission of the scheduling information; and
the number of blocks in each segment of the page, wherein a block contains a pre-determined number of bits of the TIM.

30. The method of claim 29,
wherein the scheduling information is transmitted in every beacon which comprises a segment count information element.

31. The method of claim 29,
wherein the scheduling information comprises an indication of the next target transmission time of the beacon that carries a segment count information element for the current page.

32. The method of claim 29,
wherein the scheduling information comprises an indication of an offset between the beacon that carries the first segment of the page and the current beacon that carries the scheduling information for the associated page.

33. The method of claim 29,
wherein the scheduling information is used to determine the lifetime of buffered frames for a station.

34. The method of claim 29,
wherein the scheduling information comprises an indication of a number of traffic indication map blocks being scheduled for the page.

35. The method of claim 29,
wherein the scheduling information comprises an indication of number of beacon intervals between successive beacons that carry a segment count information element for the associated page.

36. The method of claim 29,
wherein the scheduling information comprises an indication of a number of beacon intervals between successive beacons that carry a segment count information element for the page segment.

37. The method of claim 29,
wherein the scheduling information comprises an indication of a number of beacons before the next beacon that carries a segment count information element.

38. The method of claim 29,
wherein the scheduling information comprises an indication of a scheduling of segments within each segmentation interval.

39. The method of claim 29,
wherein the scheduling information comprises an indication of a page segment length in number of blocks used for the traffic indication map segmentation.

40. The method of claim 29,
wherein the scheduling information comprises an indication of a page segment length.

41. The method of claim 29,
wherein the access point is configured according to IEEE 802.11ah.

42. A method for controlling a radio communication device, the method comprising:
receiving scheduling information for a page;
wherein the page comprises one or more segments of a Traffic Indication Map (TIM); and
wherein each of the TIM segments comprises one or more bits, each bit indicating whether there is buffered data at an access point to be transmitted to a respective pre-determined radio communication terminal associated with the access point; and
wherein the scheduling information comprises at least one of the following information:
an explicit indication of an interval of one or more recurrences of subsequent transmissions of the scheduling information for the page; or
information indicating scheduling of transmission of segments of the page comprising at least:
an offset between the transmission of the first segment included in the page scheduling and the transmission of the scheduling information; and
the number of blocks in each segment of the page, wherein a block contains a pre-determined number of bits of the TIM.

43. The method of claim 42,
wherein the scheduling information is received in a beacon which comprises a segment count information element.

44. The method of claim 42,
wherein the scheduling information comprises an indication of the next target transmission time of the beacon that carries a segment count information element for the associated page.

45. The method of claim 42,
wherein the scheduling information comprises an indication of an offset between the beacon that carries the first segment of the page and the current beacon that carries the scheduling information for the associated page.

46. The method of claim 42,
wherein the scheduling information is used to determine the lifetime of buffered frames at the access point for a station associated with the access point.

47. The method of claim 42,
wherein the scheduling information comprises an indication of a number of traffic indication map blocks being scheduled for the page.

48. The method of claim 42,
wherein the scheduling information comprises an indication of number of beacon intervals between successive beacons that carry a segment count information element for the associated page.

49. The method of claim 42,
wherein the scheduling information comprises an indication of a number of beacon intervals between successive beacons that carry a segment count information element for the page segment.

50. The method of claim 42,
wherein the scheduling information comprises an indication of a number of beacons before the next beacon that carries a segment count information element.

51. The method of claim 42,
wherein the scheduling information comprises an indication of a scheduling of segments within each segmentation interval.

52. The method of claim 42,
wherein the scheduling information comprises an indication of a page segment length in number of blocks used for the traffic indication map segmentation.

53. The method of claim 42,
wherein the scheduling information comprises an indication of a page segment length.

54. The method of claim 42,
wherein the radio communication device wakes up based on its scheduling information.

55. The method of claim 42,
wherein the radio communication device wakes up independent from its page number.

56. The method of claim 42,
wherein the radio communication device is configured according to IEEE 802.11ah.
